(19) United States
(12) Patent Application Publication
(10) Pub. No.: US 2015/0339363 A1
(43) Pub. Date: Nov. 26, 2015

(54) METHOD, SYSTEM AND INTERFACE TO FACILITATE CHANGE OF AN EMOTIONAL STATE OF A USER AND CONCURRENT USERS

(71) Applicant: NEXT INTEGRATIVE MIND LIFE SCIENCES HOLDING INC., Toronto (CA)

(72) Inventors: Mihnea Calin MOLDOVEANU, Toronto (CA); David FOLK, Toronto (CA)

(21) Appl. No.: 14/404,223

(22) PCT Filed: May 31, 2013
(86) PCT No.: PCT/CA2013/000537

§ 371 Date: Nov. 26, 2014

Related U.S. Application Data
(60) Provisional application No. 61/654,535, filed on Jun. 1, 2012.

(51) Int. Cl. G06F 17/30; G06F 3/0484; G06F 3/0482

(52) U.S. Cl. CPC G06F 17/30572; G06F 17/30554; G06F 17/3053; G06F 3/0482; G06F 3/04842; G06F 17/30595

(57) ABSTRACT

A method, system and device for enabling a user to achieve modification or transformation of his emotional states are disclosed. The method utilizes a mapping of one or more of behavioural, sensory-visceral, attentional-perceptual, cognitive, and meta-cognitive states associated with an emotional state and on the user's understanding of the neurophysiological states and mechanisms underlying his emotional states to produce a blueprint that enables the user to use his understanding of his brain and other physiological states associated with an emotional state to effect the desired changes in his emotional state.

### RELATED APPLICATION

This application claims priority to U.S. Provisional Patent Application Ser. No. 61/654,535, filed on Jun. 1, 2012, which is incorporated herein by reference.

### FIELD OF THE DISCLOSURE

This disclosure relates to the field of self-directed adaptive change and personal transformation, and more specifically, to a method and system that provides an interface to accept input(s) that may be used to identify a current emotional state of a user, to identify an exit path and destination emotional state from the current state, and to identify one or more actions to facilitate changes from the current state.

### BACKGROUND OF THE DISCLOSURE

The fields of affective and cognitive neuroscience, neuroeconomics, and non-clinical neuro-psychology have collectively mapped large swaths of the neural circuitry and brain excitation patterns (“brain states”) that correspond to the emotional states of humans. Models of neurophysiological activity in sections of a brain during emotional states (e.g. fear, anger, disgust, contempt, rage, etc.) may be pieced together into a brain map from detailed neuro-imaging studies of responses of animals and subjects to stimuli that elicit these emotional states. At the same time, the field of cognitive behavioural therapy has registered success in enabling humans to conceptualize the physiological underpinning of their own emotional states as a precursor to achieving a productive “distancing” of the subject from the raw, affectively “hot” feel of certain counter-productive states, usually associated with pathological conditions. Finally, recent work on neuro-feedback and bio-feedback has shown that humans may control their own emotional states and brain states “at will” provided that they are given precise information about the underlying brain excitation patterns corresponding to the subject's response to a simple stimulus—such as a painful prick. Taken together, these findings point to a set of specific ways in which the mind may interact with the brain in order to adaptively and correctively change undesired or undesirable emotional states and brain states, and to enable one to take actions which one desires to take but has been or is otherwise unable or unwilling to take. US patent publication no. 2008/02314944 discloses a feedback system based on changes in the heart to enhance cognitive behavioural therapy.

A need therefore exists for an improved method and system for a mind-brain interface for self-directed adaptive change and personal transformation for a user.

### SUMMARY OF THE DISCLOSURE

The disclosure provides a method for the modification of an emotional state or response by the purposive and directed or self-directed (“volitional”) manipulation of a set of modification or transformation mechanisms (“levers”) that alter an emotional state by changing the neurophysiological structures and mechanisms of a user (or subject) that underlie that emotional state. The emotional state may be determined by excitations of one or more sections in the user's brain. The user may be male or female and of any age. An embodiment may provide actions for a plurality of users. The disclosure is based on the preliminary mapping and analysis of an emotional state or response (or multiple emotional states or responses) that the subject would like to modify (the target emotional state(s) or response(s)) into a set of discernible components. Herein, the term “target emotional state” or “target state” represents the current emotional state of a user and the term “goal emotional state” or “goal state” represents a desired emotional state to which the user wishes to change/transform towards. An exemplary method for such mapping is the mapping of target emotional states into a set of behavioural (“B”), attentional-perceptual (“AP”), visceral-sensorial (“VS”), cognitive (“C”), and meta-cognitive (“MC”) events, sequences of events, or event patterns. For an embodiment, an event pattern is a discernible and unitary sequence of events that correspond to an emotion or an emotional state.

The disclosure is based furthermore on the articulation of a set of executable mental and/or physical actions or action patterns (“levers”) that the user may implement to the end of a) modifying his emotional state(s) and/or b) enabling him to take actions which he desires to take but has been or is otherwise unable or unwilling to take as a direct or indirect result of his target emotional state(s) or response(s) and corresponding behaviour(s). The identification and use of levers is based on a mapping of one or more components of an emotional state or response of the subject into a set of neurophysiological states (“NP-S”) associated with the target emotional state and a set of neurophysiological structures and mechanisms (“NP-M”) associated with the modification (amplification, attenuation) or transformation of the emotional state or response in question, via the modification of the physiological and neuro-physiological state associated with it. The result is a neurophenomenological map of an emotional state or response and its modification or transformation mechanisms or levers that encapsulates the phenomenological portrait of an emotional state or response (via one or more components of the B-AP-VS-C-MC portrait of the emotional state) and the neurophysiological model of that state (including its dynamics) (see FIG. 1A). For the purpose of this disclosure the term “neurophenomenology” (and its related terms) refers generally to the study of the relationship between one's nervous system (particularly the brain) with respect to one's consciousness or mind.

A resulting brain map—which may have a topology akin to that displayed in FIG. 1B may be used in an embodiment to allow the subject to identify/analyze/assess one or more elements of his emotional state and intervene using levers to modify or transform it, in a way that is informed and reinforced by the neurophysiological structures and mechanisms associated with that emotional state. These levers comprise a set of executable actions—behaviours of a physical and/or mental type that are internally caused and purposefully executed—that the subject can undertake, and which may include: changes in the depth and/or rate and/or rate of change of the rate of inspiration, changes in body posture, changes in local pressure applied by the limbs against opposing surfaces, including parts of the subject's body, changes in the immediate focus of attention, changes in the propositional content of the subject's thoughts (when descriptions of same are provided by the user), and changes in the perspective the subject takes of the content of the subject's thoughts. The neurophysiological model of an emotional state makes it possible to design and deploy a set of moves, tactics and strategies aimed at changing the (B-AP-VS-C-MC) vector of states comprising an emotional state by changing the underlying physiology associated with it. In an embodiment the person making use of the map and the associated set of levers is directed to train his mind to purposefully and volitionally manipulate his brain to modify or transform an emotional state and to enable the subject to take one or more actions that he may decide to conduct according to the selected change in his emotional state. The disclosure provides an iterative application of a mapping exercise meant to determine the range of states that are controllable by different levers and the range of emotional state modifications or transformations that are volitionally accessible to a person on the basis of a brain map and/or a body map of the emotional state. In an embodiment the subject may employ levers and/or other actions without the use of brain and/or body maps.

According to one aspect of the disclosure, there is provided a computer system (or data processing system) for providing a human subject with a set of one or more actions intended to modify or transform an emotional state of the human subject, comprising: at least one processor; and one or more storage media containing software code and a database, which software, when executed by the processor, causes the computer system to: prompt the human subject for input regarding his current emotional state; receive input from the human subject representative of his emotional state; determine, based on the input and by accessing a database to which the input is compared, one or more actions intended to cause a change in the emotional state of the human subject; provide a description of at least one action that is sufficiently detailed to allow the human subject to initiate and perform the action; prompt the human subject for feedback regarding the success of the action in changing said emotional state; and, update the database according to input received from the human subject, which may be in the form of a text description of the current emotional state or selection of a particular emotional state from a list of states or an inferred emotional state determined from an analysis of biometric data of the subject (e.g. body temperature, blood pressure, heart rate, etc.).

According to another aspect of the disclosure, there is provided a method for providing a human subject with one or more actions intended to change the human subject's brain activation state, comprising: receiving, as input into a computing device, information that identifies a first emotional state of the human subject and also information that identifies a second emotional state; determining, by the computing device accessing a database and based on the first and second emotional states, a first brain activation pattern associated with the first emotional state of the human subject and also a second brain activation pattern associated with the second emotional state; determining, by the computing device accessing the database and based on the first and second brain activation states, at least one action to be performed by the human subject with the goal of changing the first brain activation pattern to the second brain activation pattern; and, outputting from the computing device information that allows the human subject to understand and perform at least one action with the goal of producing a change in the subject's brain from the first brain activation pattern to the second brain activation pattern; and thus also changing the human subject's emotional state from the first emotional state to the second emotional state. For an embodiment, a brain activation state refers to what sections of a user's brain are activated and when, while an emotional state refers to what a user may be determined to be experiencing at a given time, which may have a brain activation state associated with it.

In accordance with further aspects of the disclosure there is provided an apparatus such as a system for gathering physical, physiological and neurophysiological data about the subject, a data processing system, a method for adapting this apparatus, as well as articles of manufacture such as a computer readable medium or product having program instructions recorded thereon for practising the method of the disclosure.

### BRIEF DESCRIPTION OF THE DRAWINGS

Further features and advantages of the embodiments of the disclosure will become apparent from the following detailed description, taken in combination with the appended drawings, in which:

FIG. 1A is a flow chart illustrating a process for modifying an emotional state via neurophenomenological mapping in accordance with an embodiment of the disclosure;

FIG. 1B is a schematic diagram illustrating target emotional states, phenomenological mapping of the emotional states, neurophysiological mapping of the phenomenological states, and a set of levers for modifying/transforming target emotional states, in accordance with an embodiment;

FIG. 1C(i) is a flow chart of an algorithm of a process for emotional state modification or transformation in accordance with an embodiment;

FIG. 1C(ii) is another flow chart of another algorithm of a process for emotional state modification or transformation in accordance with an embodiment;

FIG. 1D is a block diagram illustrating a computer or tablet equipped with a database of neurophysiological structures and mechanisms, outputs, screens and GUIs for displaying user states, and outputs, screens and GUIs for accepting input from and by a user, in accordance with an embodiment;

FIG. 2 is a diagram illustrating a two-dimensional map of emotional states described by adjectives, and by the degree to which they are rated by humans as more or less active and more or less positive, in accordance with an embodiment;

FIG. 3 is a diagram illustrating a brain map for the sensory system in accordance with an embodiment;

FIG. 4 is a diagram illustrating a brain map for the somatosensory cortex in accordance with an embodiment;

FIG. 5 is a diagram illustrating a brain map for the attention distribution and targeting system in accordance with an embodiment;

FIG. 6 is a diagram illustrating a brain map for the memory system in accordance with an embodiment;

FIG. 7 is a diagram illustrating a brain map for the cognitive system in accordance with an embodiment;

FIG. 8 is a diagram illustrating a brain map for the motor control system in accordance with an embodiment;

FIG. 9 is a diagram illustrating a detailed brain map for the motor cortex in accordance with an embodiment;

FIG. 10 is a diagram illustrating a structural map of the central nervous system in accordance with an embodiment;

FIG. 11 is a diagram illustrating a functional map of the spinal cord in accordance with an embodiment;

FIG. 12 is a diagram illustrating a functional map of the somatic sensory system in accordance with an embodiment;

FIG. 13 is a diagram illustrating a functional map of the somatic motor system in accordance with an embodiment;

FIG. 14 is a diagram illustrating a functional map of the sympathetic nervous system in accordance with an embodiment;

FIG. 15 is a diagram illustrating a functional map of the parasympathetic nervous system in accordance with an embodiment;

FIG. 16 is a chart providing a summary of outputs of each stage of the outputs, screens and GUIs for facilitating modification or transformation of fear, as it arises in an emotional episode called public speaking, in accordance with an embodiment;

FIG. 17 is a diagram illustrating a brain map of the behavioral response associated with fear in accordance with an embodiment;

FIG. 18 is a diagram illustrating a brain map of the attentional-perceptual response associated with fear in accordance with an embodiment;

FIG. 19 is a diagram illustrating a brain map of the visceral-sensory response associated with fear in accordance with an embodiment;

FIG. 20 is a diagram illustrating a brain map of the cognitive response associated with fear in accordance with an embodiment;

FIG. 21 is a diagram illustrating a brain map of the meta-cognitive response associated with fear in accordance with an embodiment;

FIG. 22 is a diagram illustrating a body map for somatic motor system correlates of fear in accordance with an embodiment;

FIG. 23 is a diagram illustrating a body map for sympathetic nervous system correlates of fear in accordance with an embodiment;

FIG. 24 is a diagram illustrating a body map for parasympathetic nervous system correlates of fear in accordance with an embodiment;

FIG. 25 is a diagram illustrating a brain map showing exemplary effects of behavioral levers for modification or transformation of fear in accordance with an embodiment;

FIG. 26 is a diagram illustrating a brain map showing exemplary effects of attentional-perceptual levers for modification or transformation of fear in accordance with an embodiment;

FIG. 26A is a diagram illustrating a brain map showing exemplary effects of visceral-sensorial levers for modification or transformation of fear in accordance with an embodiment;

FIG. 27 is a diagram illustrating a brain map showing exemplary effects of cognitive levers for modification or transformation of fear in accordance with an embodiment;

FIG. 28 is a diagram illustrating a brain map showing exemplary effects of meta-cognitive levers for modification or transformation of fear in accordance with an embodiment;

FIG. 29 is a chart providing a summary of outputs of each stage of the outputs, screens and GUIs for facilitating modification or transformation of disgust as it arises in a specific emotional episode in accordance with an embodiment;

FIG. 30 is a diagram illustrating a brain map of the behavioral response associated with disgust in accordance with an embodiment;

FIG. 31 is a diagram illustrating a brain map of the attentional-perceptual response associated with disgust in accordance with an embodiment;

FIG. 32 is a diagram illustrating a brain map of the sensory-visceral response associated with disgust in accordance with an embodiment;

FIG. 33 is a diagram illustrating a brain map of the cognitive response associated with disgust in accordance with an embodiment;

FIG. 34 is a diagram illustrating a brain map of the meta-cognitive response associated with disgust in accordance with an embodiment;

FIG. 35 is a diagram illustrating a body map of the somatic sensory system response associated with disgust in accordance with an embodiment;

FIG. 36 is a diagram illustrating a body map of the somatic motor system response associated with disgust in accordance with an embodiment;

FIG. 37 is a diagram illustrating a body map of the sympathetic nervous system response associated with disgust in accordance with an embodiment;

FIG. 37A is a diagram illustrating a body map of the parasympathetic system response associated with disgust in accordance with an embodiment;

FIG. 38 is a diagram illustrating a brain map showing exemplary effects of behavioral levers for modification or transformation of disgust in accordance with an embodiment;

FIG. 39 is a diagram illustrating a brain map showing exemplary effects of attentional-perceptual levers for modification or transformation of disgust in accordance with an embodiment;

FIG. 40 is a diagram illustrating a brain map showing exemplary effects of sensory-visceral levers for modification or transformation of disgust in accordance with an embodiment;

FIG. 41 is a diagram illustrating a brain map showing exemplary effects of cognitive levers for modification or transformation of disgust in accordance with an embodiment;

FIG. 42 is a diagram illustrating a brain map showing exemplary effects of cognitive levers for modification or transformation of disgust in accordance with an embodiment;

FIG. 43 is a chart providing a summary of outputs of each stage of the outputs, screens and GUIs for facilitating modification or transformation of anger as it arises in a specific emotional episode in accordance with an embodiment;

FIG. 44 is a diagram illustrating a brain map of neurophysiological structures and mechanisms underlying the behavioral response associated with anger in accordance with an embodiment;

FIG. 45 is a diagram illustrating a brain map of neurophysiological structures and mechanisms underlying the attentional-perceptual response associated with anger in accordance with an embodiment;

FIG. 46 is a diagram illustrating a brain map of neurophysiological structures and mechanisms underlying the visceral-sensorial response associated with anger in accordance with an embodiment;

FIG. 47 is a diagram illustrating a brain map of neurophysiological structures and mechanisms underlying the visceral-sensorial response associated with anger in accordance with an embodiment;

FIG. 48 is a diagram illustrating a brain map of neurophysiological structures and mechanisms underlying the visceral-sensorial response associated with anger in accordance with an embodiment;

FIG. 49 is a diagram illustrating a body map of the somatic sensory system response associated with anger in accordance with an embodiment;

FIG. 50 is a diagram illustrating a body map of the somatic motor system response associated with anger in accordance with an embodiment;

FIG. 51 is a diagram illustrating a body map of the sympathetic nervous system response associated with anger in accordance with an embodiment;

FIG. 52 is a diagram illustrating a body map of the para-sympathetic nervous system response associated with anger in accordance with an embodiment;

FIG. 53 is a diagram illustrating a brain map showing exemplary effects of behavioral levers for modification or transformation of anger in accordance with an embodiment;

FIG. 54 is a diagram illustrating a brain map showing exemplary effects of attentional-perceptual levers for modification or transformation of anger in accordance with an embodiment;

FIG. 55 is a diagram illustrating a brain map showing exemplary effects of visceral-sensorial levers for modification or transformation of anger in accordance with an embodiment;

FIG. 56 is a diagram illustrating a brain map showing exemplary effects of cognitive levers for modification or transformation of anger in accordance with an embodiment;

FIG. 57 is a diagram illustrating a brain map showing exemplary effects of meta-cognitive levers for modification or transformation anger in accordance with an embodiment;

FIG. 58 is a block diagram illustrating a data processing system in accordance with an embodiment;

FIGS. 59A-59H are exemplary GUIs produced by an embodiment in generating outputs to solicit information and receive inputs about an emotional state from a user in accordance with an embodiment;

FIGS. 60A-60B are exemplary GUIs produced by an embodiment in generating outputs to order thoughts and behaviours for an emotional state from a user in accordance with an embodiment;

FIGS. 61A-61B are exemplary GUIs produced by an embodiment in generating outputs to transit from an emotional state from a user after an analysis is conducted in accordance with an embodiment;

FIG. 62 is an exemplary GUI produced by an embodiment in generating an output to solicit feedback for inputs to evaluate the levers in transiting from an emotional state from a user in accordance with an embodiment; and

FIG. 63 is a block diagram of an embodiment showing features of a user-to-user analysis of an emotional state.

It will be noted that throughout the appended drawings, like features are identified by like reference numerals.

### DETAILED DESCRIPTION OF THE EMBODIMENTS

In the following description, details are set forth to provide an understanding of the disclosure. In some instances, certain software, algorithms, processes, circuits, structures and methods have not been described or shown in detail in order not to obscure the disclosure. The term “data processing system” is used herein to refer to any machine for processing data, including the computer systems, wireless devices, and network arrangements described herein. The disclosure may be implemented in any computer programming language provided that the operating system of the data processing system provides the facilities that may support the requirements of the disclosure. Any limitations presented would be a result of a particular type of operating system or computer programming language and would not be a limitation of the disclosure. The disclosure may also be implemented in hardware or in a combination of hardware and software.

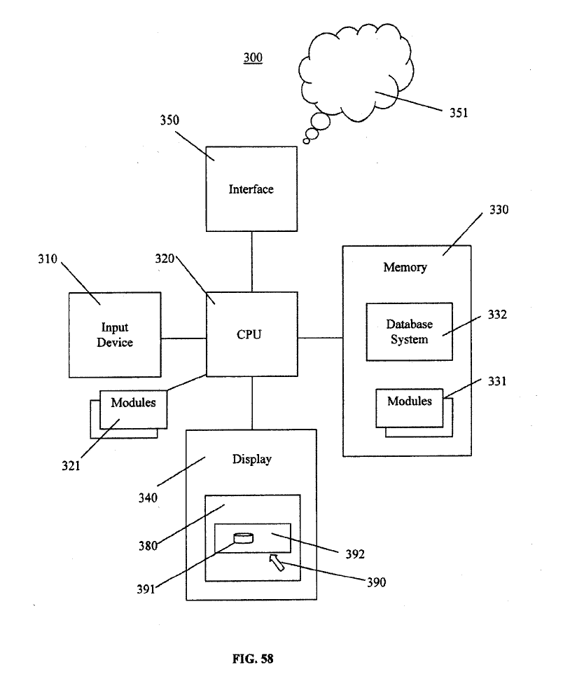

FIG. 58 is a block diagram illustrating a data processing system 300 in accordance with an embodiment. The data processing system 300 is suitable for generating, displaying, and adjusting presentations in conjunction with a graphical user interface (“GUI”), as described below. The data processing system 300 may be a client and/or server in a client/server system. For example, the data processing system 300 may be a server system, laptop computer, tablet computing device, smart phone or a personal computer (“PC”) system or a combination thereof. The data processing system 300 may also be a wireless device or other mobile, portable, or handheld device. The data processing system 300 includes an input device 310, a central processing unit (“CPU”) 320, memory 330, a display 340, and an interface device 350. The input device 310 may include a keyboard, a mouse, a trackball, a touch sensitive surface or screen, a position tracking device, an eye tracking device, a biometric device, or a similar device. The display 340 may include a computer screen, television screen, display screen, terminal device, a touch sensitive display surface or screen, or a hardcopy producing output device such as a printer or plotter or a similar device. The memory 330 may include a variety of storage devices including internal memory and external mass storage typically arranged in a hierarchy of storage as understood by those skilled in the art. For example, the memory 330 may include databases, random access memory (“RAM”), read-only memory (“ROM”), flash memory, and/or disk devices. The interface device 350 may include one or more network connections. The data processing system 300 may be adapted for communicating with other data processing systems (e.g., similar to data processing system 300) over a network 351 via the interface device 350. For example, the interface device 350 may include an interface to a network 351 such as the Internet and/or another wired or wireless network (e.g., a wireless local area network (“WLAN”), a cellular telephone network, etc.). As such, the interface 350 may include suitable transmitters, receivers, antennae, etc. Thus, the data processing system 300 may be linked to other data processing systems by the network 351. The CPU 320 may include or be operatively coupled to dedicated coprocessors, memory devices, or other hardware modules 321. The CPU 320 is operatively coupled to the memory 330 which stores an operating system (e.g., 331) for general management of the system 300. The CPU 320 is operatively coupled to the input device 310 for receiving user signals, commands or queries and for displaying the results of these signals, commands or queries to the user on the display 340. Commands and queries may also be received via the interface device 350 and results may be transmitted via the interface device 350. The data processing system 300 may include a database system 332 (or store) for storing data and programming information from the user and multiple other users, correlated data from users and using the correlated data to generate, display, and adjust presentations in conjunction with the graphical user interface (“GUI”). The database system 332 may include a database management system and a database and may be stored in the memory 330 of the data processing system 300. The database management system may be provided by commercially available database software, such as Access (trade-mark) from Microsoft or any SQL-based database system. In general, the data processing system 300 has stored therein records of data of emotional states of users, levers that may cause an effect on an emotional state, relationships among the users and levers and data representing sequences of instructions which when executed cause methods and processes described herein to be performed. The data processing system 300 may contain additional software and hardware a description of which is not necessary for understanding the disclosure.

For an embodiment, the data processing system 300 includes computer executable programmed instructions that are executable on a microprocessor and that cause the microprocessor to direct system 300 to implement embodiments of the disclosure. The programmed instructions may be embodied in one or more hardware modules 321 or software modules 331 resident in the memory 330 of the data processing system 300 or elsewhere. Alternatively, the programmed instructions may be embodied on a computer readable medium or product (e.g., a compact disk (“CD”), a floppy disk, etc.) which may be used for transporting the programmed instructions to the memory 330 of the data processing system 300. Alternatively, the programmed instructions may be embedded in a computer-readable signal or signal-bearing medium or product that is uploaded to a network 351 by a vendor or supplier of the programmed instructions, and this signal or signal-bearing medium or product may be downloaded through an interface (e.g., interface device 350) to the data processing system 300 from the network 351 by end users or potential buyers.

A user may interact with the data processing system 300 and its hardware and software modules 321, 331 using a graphical user interface (“GUI”) 380. The GUI 380 may be used for monitoring, managing, and accessing the data processing system 300. GUIs are supported by common operating systems and provide a display format which enables a user to input data, choose commands, execute application programs, manage computer files and perform other functions by selecting pictorial icons or items from a menu through use of an input device 310 such as a mouse, touchscreen or other input device. In general, a GUI is an input/output interface for an application that can receive data/commands or convey information from a user and generally includes a variety of GUI objects or controls, including icons, toolbars, drop-down menus, text, dialog boxes, buttons, and the like. A user typically interacts with a GUI 380 presented on a display 340 by using an input device (e.g., a mouse, touchpad or touchscreen) 310 to position a pointer or cursor 390 over an object (e.g., an icon) 391 and by “clicking” on the object 391. Typically, a GUI based system presents application, system status, and other information to the user in one or more “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area. The GUIs may contain data, information, text, graphics, and videos generated by an application as an output that identify one or more actions that a user is encouraged to take in order to effect a change of state per an embodiment. With the GUI, the related device may also have a speaker that can generate sounds/music/spoken words from data files provided to it. The output of the speaker may augment the output provided in the GUI. For example, if the GUI is displaying a video, the speaker may generate a corresponding soundtrack; if the GUI is generating text describing a suggested action to be undertaken by the user, the speaker may generate a corresponding oral reading of the text and/or sounds or music that enhance the suggested action (for example, if the action is to have the user be “calm”, soft music may be played through the speaker).

Other outputs and control signals and messages may be generated. For example, control signals may be generated that control an operating condition of an exercise machine. For example, a treadmill may be controlled to increase or decrease its speed or inclination, depending on whether a desired output is to have the user increase or decrease his current level of physical activity, while he is using the system and concurrently on the treadmill. For a further example, control signals may be generated that control heating/cooling settings, open/close window shades, turn on/turn off lights in a room where the user is currently located depending on whether a desired output is to have the user be located in an ambient condition (temperature, lighting, air quality, etc.), while he is using the system and concurrently in that room. For a further example, signals may be sent to the user's and/or another user's PC desktop, laptop, tablet or handled device (i.e. smart phone, mini tablet) via the user's email account, text messaging system, calendaring system, notes system or other similar system resident on the user's device and such system(s) may store details of actions and reminders to take those actions in a variety of video, textual and auditory formats. For a further example, signals may be sent to the user's and/or another user's biometric device(s) to prompt the device to gather information, alter the way it is already gathering information and inputting information via input device 310, or send signals instructions to the user.

It will be seen that links between records in the database may be set, changed and terminated using an analysis of actions conducted by the users when they are in certain states and what the resulting change in state(s) were. The database and the analysis may utilize data from research and other sources to assign weightings, rankings and/or thresholds in evaluating and identifying which set of lever(s) are associated with a given emotional state. Based on the ranking, an analysis of the records in the database can identify levers that are more “highly ranked” (i.e. more effective) which then may be presented as an output on a device which is shown to a user when he is experiencing a given state and it is determined that a certain action has been requested to either leave the state or go to a goal state.

An embodiment may provide additional processing algorithms to determine how outputs to future subjects using the system will be determined so as to benefit from statistical and other correlations of subject responses. Effectively, additional records in the database from different users provide a larger dataset of emotional states and triggers. The database has more information about users' emotional states, brain states, lever usages and other correlated information. This information can be tracked as usage data and the usage data may be analyzed to identify levers statistically having “more effect” for a desired action for a given emotional state.

An aspect of the disclosure lies is at an intersection of the fields of mental health and well-being, the psychotherapeutic treatment of mood and anxiety disorders, the affective and cognitive neurosciences, and the sciences and disciplines of short-term or long-term behavioural modification, such as virtual reality therapy. An embodiment relates to a method for mapping, tracking, modifying and/or transforming the emotional states of human subjects in productive and purposive ways, and in a fashion that is guided by a relatively accurate close and up-to-date phenomenological and neurophysiological understanding of the subject's emotional states, which is embedded in processes, systems, data and algorithms for mapping a plain language description of an emotional state onto a phenomenologically and neuroscientifically precise language system. An embodiment facilitates modification of emotional states of a user, for example, states that are counter-productive for the user experiencing them, either in inter-personal or individual settings. It also facilitates exiting a current emotional state and/or transitioning towards one or more desirable emotional states than the present state currently experienced and to enable the subject to take actions that he may wish to take according to the modification or transformation that the actions produce in his emotional state vs. actions he may otherwise take.

An embodiment utilizes mappings of various emotional states and responses of humans using data provided from measurement devices, such as functional magnetic resonance imaging (“fMRI”), positron emission tomography (“PET”) and electroencephalographic (“EEG”) devices providing examination of the specific brain and other neural structures implicated in (i.e., co-active or correlated with) the experience of emotional states and impulses. Significant completed and ongoing work seeks to reconstruct the neurological structures and neurophysiological mechanisms associated with emotional states and responses in humans, for the purpose of better assessing the basic mechanisms or emotional responses or the degree to which such emotional responses are impaired by injury, trauma, stress or disease. The disclosure provides a method, process, system and device by which current and future neurophysiological understanding of emotional states may be used in a therapeutic or transformational setting to enable substantive self-directed change and personal transformation.

An embodiment provides a set of therapeutic methods for behavioral and affective changes that uses a person's understanding of his feelings and thoughts as being shaped by, constrained by, influenced by or supervenient upon the way that person's brain “works”. An embodiment provides a method of enabling an individual to visualize and structure his understanding of un-desired or counter-productive emotional states (e.g. emotional states experienced by patients having obsessive compulsive disorders) using a neuro-physiological understanding of those states, and to tailor a personal plan and effort for modification or transformation on the basis of this neurophysiological self-understanding and ongoing feedback regarding the success that the subject has registered in the past aided by a system like the system represented by FIG. 58. An embodiment produces outputs on one or more devices that facilitate the subject to take actions that he may wish to conduct according to the change that is desired in view of his current emotional state.

Also, an embodiment utilizes understandings of the behavioural, visceral-sensory, attentional-perceptual, cognitive and meta-cognitive manifestations of an emotional state. It has been observed that an emotion is caused or is constituted by the conscious experience of physiological and/or visceral states that one usually takes to be consequent to it: one does not hyperventilate because one is anxious or fearful, but, rather, one is anxious or fearful because one hyperventilates; or, it is the conscious experience of the hyperventilation that is part of the behavioral component of the aftermath of exposure to a frightening stimulus. This view of emotions is mapped by an embodiment into a set of n-dimensional representations of what an emotional state “is”, or, “is constituted by”. For one embodiment, the representation is based on a premise that an emotional state is constituted by a set of five components: behavioural (“B”), attentional-perceptual (“AP”), visceral-sensorial (“VS”), cognitive (“C”), and meta-cognitive (“MC”) states. These components may be mapped to various degrees onto a set of neurophysiological structures and mechanisms. Mappings and associations for the components to the emotional states may be on a 1:1 or 1:N or M:N basis, depending on the nature of the relationships. Each of these components may be associated with qualitative data, such as text describing a value for a component, and/or quantitative data, such as a specific selected value from a list or range of values (e.g. from a list comprising specific values) or measured physical data (e.g. body temperature, blood pressure, heart rate, etc.).

An emotion is a complex entity, with concomitant correlates in the behavioural, attentional-perceptual, visceral-sensorial, cognitive and meta-cognitive dimensions. Together, these dimensions comprise a phenomenological “portrait” or representation of that emotion. For example in an embodiment, a “rage” emotion may be represented as a set of behaviours (aggressive movements, bodily agitation), attentional-perceptual (image of intended target of destruction, transient loss of visual acuity (“seeing red”), visualization of damage done to target of emotion), visceral-sensorial (feeling of heat in the face, transient loss of sensation in hands and arms), cognitive (thoughts of paths for destroying object of rage and planning for consequences of the destruction) and meta-cognitive (objectifying one's loss of control over one's own “rage response”) that collectively define or constitute what it means for that subject to be in a state of rage.

An embodiment utilizes a premise that it is neither the emotion (rage) that “causes” the states of being, nor the states that “cause” the emotion (as per a James-Lange model). Instead, an embodiment utilizes a configuration of states and sequences of states of being to define and quantify an emotion. In one embodiment, characterization and changing an emotion is effected by making one or more changes to one or more components of the set of behavioral, attentional-perceptual, sensory-visceral, cognitive and meta-cognitive states associated with the emotion. To the extent that these different components of an emotional state are correlated with the excitation of certain neurological structures—both in the brain and in the peripheral nervous system—changing an emotional state or pattern via changes in these components will also change the underlying pattern of excitation of the neurological structures.

Also, an embodiment provides analysis and articulation and patterned usage of a set of behavioural and mental (including both attentional (“focus on this”) and cognitive (“think of that”)) levers for the modification of one's own emotional states, which produce changes in emotional states via changes in the behavioral, attentional-perceptual, visceral, cognitive or meta-cognitive states of the subject. It utilizes in part data on neurophysiological changes underlying meditative and mantric practices associated with Eastern practices. For example, specific actions (e.g. meditation) may be associated with a lever to affect an emotional state of “calm” in a person. This relationship may be captured as in records of a database of an embodiment and links made between the records to other records in the database. According to one view, such practices may be classified as those that seek to increase self-regulative potential on the basis of “focused attention” on a very specific inner or outer stimulus and those who seek heightened levels of self-regulation on the basis of an “open monitoring” by the subject of his emotional states and thoughts associated therewith. Activation or execution of a particular set of levers, or actions may cause a person to direct his mind and body to perform with or without the assistance of a human guide. The degree of efficacy of a meditative practice as a self-regulation tool or technique may—though it need not—be inferred from the degree to which it makes use of “tested” neuro-physiological mechanisms for modification or transformation of emotional states.

Features of an embodiment provide (self) transformations that enable a person to change or transform an acquired neuro-physiological self-understanding into a generator for a set of levers that the person may use in order to modify or transform his emotional states in a purposive fashion. Such levers may include those actions associated with Eastern meditative practices. In this embodiment these levers are generated by the user at will rather than from the data processing system 300 and the components of the lever and its effectiveness serve to inform the database for the user's and other users' future benefit. Inhibition of counter-productive emotional states (disgust with an “unfair” offer in an economic ultimatum game, leading to the rejection of a Pareto-efficient offer) may be achieved through short-term training and practice in Eastern meditative practices that help subjects to effectively become “more rational” in ultimatum game like situations. The disclosure facilitates a user in designing/augmenting/controlling/changing his emotional and visceral states according to his considered ends and goals.

An embodiment provides a set of methods, processes, analyses, techniques and procedures for emotional self-regulation based on the specification, registration and manipulation of a particular set of the subject's own physiological states. An embodiment provides purposive self-regulation and development or enhancement of a “will” via repeated exercises aimed at reining in impulses or impulsive desires. For an embodiment, self-control and self-regulation are considered to be capabilities that may be appropriated through learning and practice that is aimed at overcoming or changing a current emotional state. The sort of emotional self-transformation that is envisaged in this disclosure may be understood as an enhanced and elaborate form of self-regulation and training therefore. For example, one goal of the regulator may be to inhibit an impulsive desire that has ex post undesirable consequences (e.g. fear, panic, disgust, rage, etc.) as well as to produce a new emotional state (which may include an impulse or desire to learn or to relate) with more desirable consequences. For another example, a goal of the regulator may be transition from a current target emotional state (fear, panic, disgust, rage) to a different emotional state without a specific goal state in mind, except to not be at the affect or effect of the current target state.

An embodiment provides a user with outputs that facilitate self-regulation of his emotional patterns via direct and volitional manipulation of his brain states. A user equipped with devices embodying features of the disclosure allow him to track his brain-level activation patterns via univariate or multivariate (real time or near real time) data (e.g. from real time fMRI-RT-fMRI-machines). An embodiment may identify a state using this data (or other data) and switch off a subjective experience of an emotional or visceral state (“pain”) and/or neurophysiological correlates of that state (excitation of the rostro-anterior cingulate cortex (“rACC”), for instance).

An embodiment facilitates a user to acquire volitional control of his brain activity in specified domains through a variety of methods, including cognitive, visceral, attentional-perceptual and behavioural. The degree to which a user controls his brain in ways that are causally related to his intent to do so is related to the proximity of the feedback link between the real time brain imaging device and his perceptual field: what matters to the achievement of volitional control is the presence of a real time feedback signal between the brain state changes and his perceptual field as he attempts to train his mind to control his brain. A method of an embodiment trains and develops a user by interacting with and exerting volitional control over his brain states (and perforce his emotional states), preferably without the use of a real time imaging protocol and associated machinery. It does so by unpacking a range of levers by which a user may volitionally change his brain states and replacing real-time feedback from a brain scanner (e.g., RT-fMRI) with detailed mapping of the subject's emotional states onto the brain and neural structural and mechanisms likely to be implicated in it, and with detailed feedback from the user about the effectiveness of the levers they used to modify or transform his emotional state. Another embodiment provides a process directed to a similar result using a generalized mapping of the subject's emotional states instead of a mapping of the subject's emotional states onto the brain and neural structural and mechanisms, and with generalized feedback in GUIs that is sufficiently compelling to the user that he are able to train himself to utilize levers from the data processing system 300 and of his design and thereby learn to volitionally modify his emotional states and to facilitate taking actions that he may wish to take according to the change produced in his emotional state vs. actions he may otherwise take.

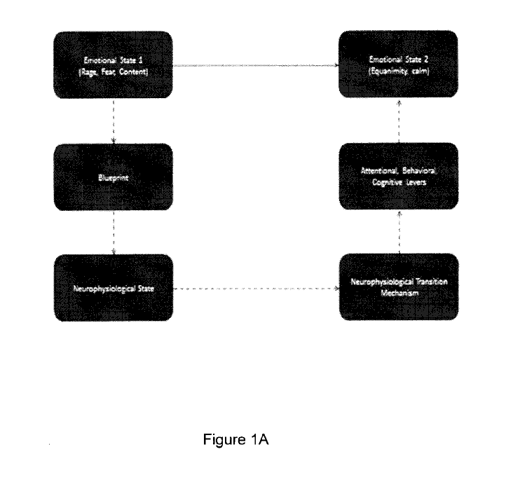

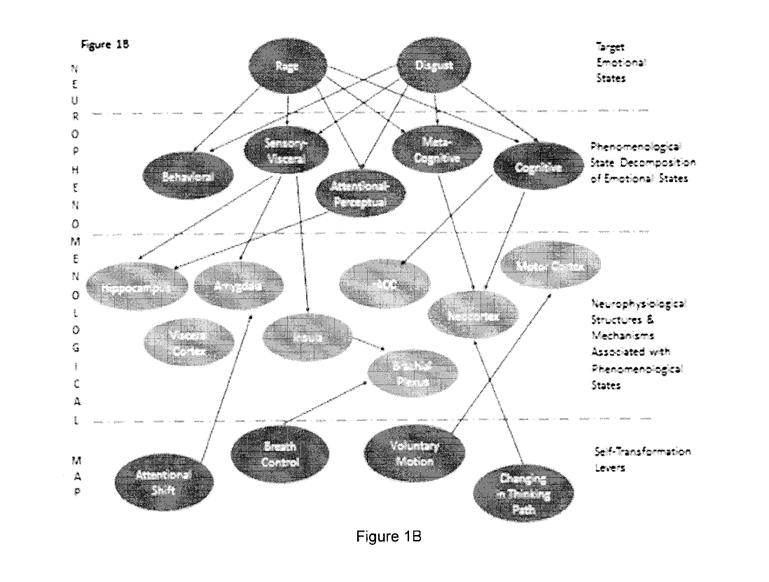

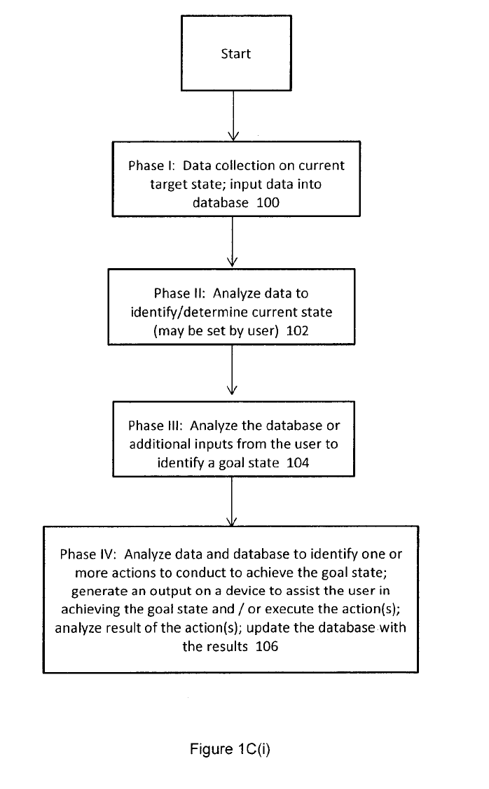

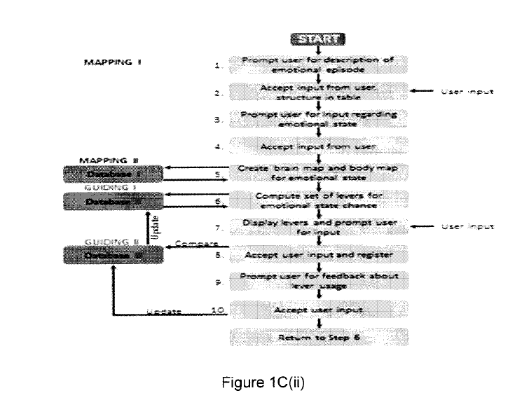

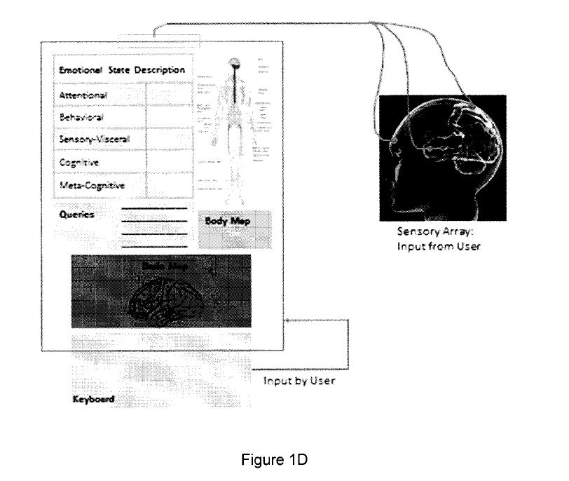

FIG. 1B shows an algorithm of an exemplary process showing emotional state modification or transformation in accordance with an embodiment. The protocol for achieving emotional modification or transformation may be implemented on a processor that makes use of a memory storage system and an associated data base to issue queries to the subject, interpret the subject's responses to the queries, compute neurophysiological maps (brain and body maps) associated with the subject's emotional states, prompt the subject for choices among levers or sets of levers for changing his emotional states, and provide interfaces for the subject to input results of his past use of suggested levers. This provides a feedback loop to improve the performance of an embodiment.

FIGS. 1C(i) and 1C(ii) show algorithms of exemplary processes providing an emotional state modification or transformation. FIG. 1D shows an embodiment as a computer or tablet (or data processing system 300) equipped with a database of neurophysiological structures, processes and mechanisms for displaying user states, and processes, screens and inputs for accepting input from and by a user.

FIG. 1C(i) shows features of an algorithm of an embodiment having four separate phases. Phase I collects data from a user. Phase II processes the data to determine a current emotional state of the user. For an embodiment, the current state that is being changed is called a target state. Phase III identifies for the current state a transition, which is either an exit path from the current state to an unspecified state or a goal state. Phase IV identifies for actions to facilitate achieving the transition and generates a series of outputs to guide the user in the transition. Features of each phase are described in turn. It will be appreciated that in other embodiments each phase may perform more or less functions then those described herein and the order of the phases may be changed.

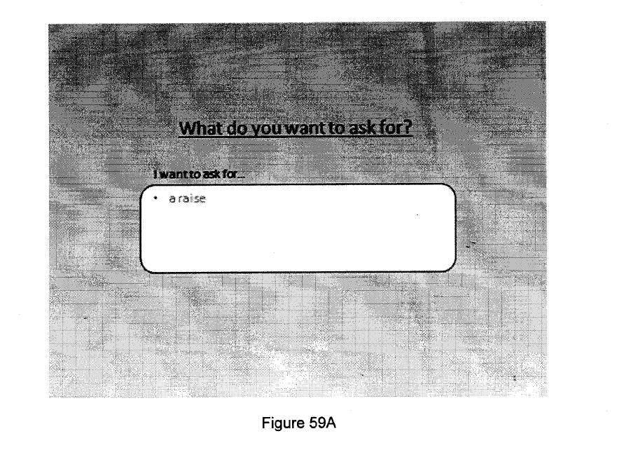

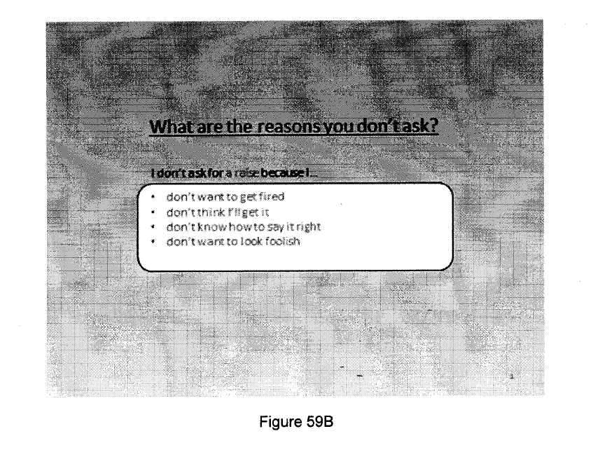

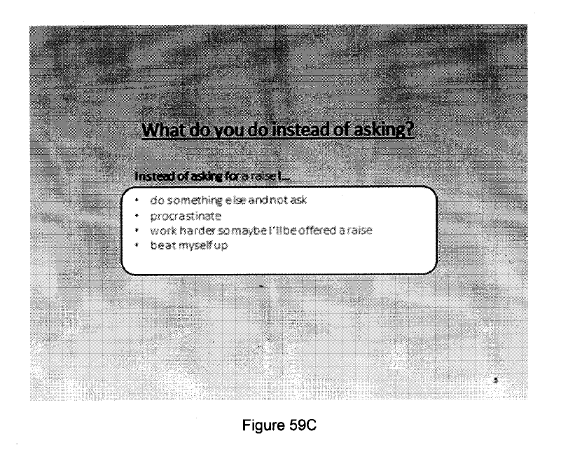

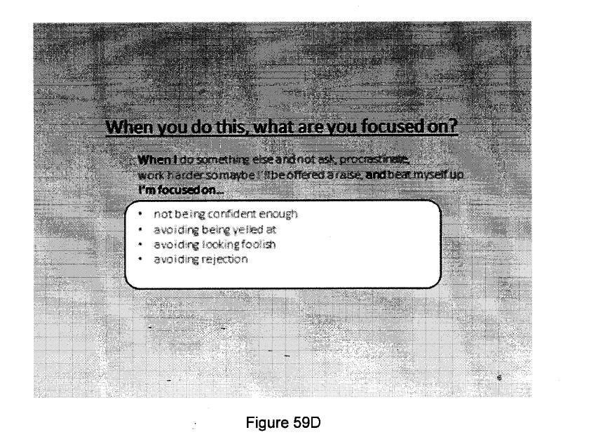

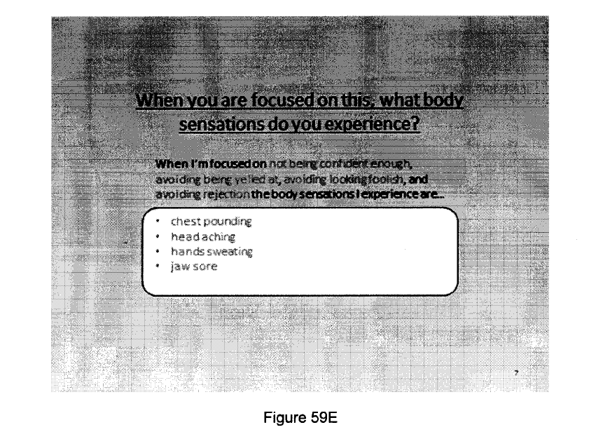

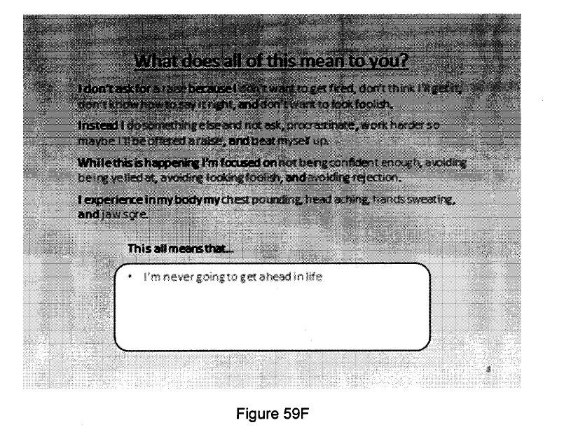

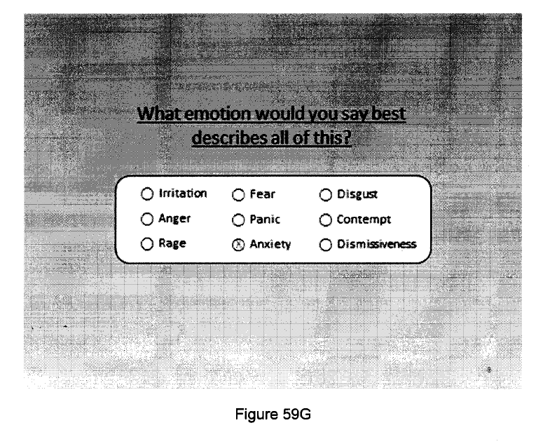

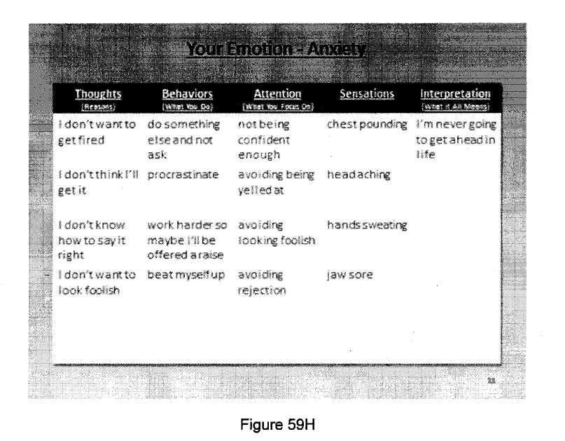

Phase I, shown at process 100 in one embodiment, determines an emotional state relying on data provided by the user. Therein, system 300 generates a series of GUIs that have input screens asking the user a series of questions as to: his biological information, the current location, day and time, the current or target emotional state as deemed by the user. Then a series of questions are presented prompting the user to provide details on current components of the current or target emotional state being subjectively experienced by the user, namely for one or more of the B, AP, VS, C and MC components as vectors of data. The user may or may not have data for each of the components. As the data is entered in the GUI it is stored in a database system 332. The data is stored in a database as a searchable record with identification parameters (e.g. time, date, location, personal identification) and details regarding the target state. FIGS. 59A-59H show exemplary GUIs produced by an embodiment in generating outputs to solicit information and receive inputs about an emotional state from a user.

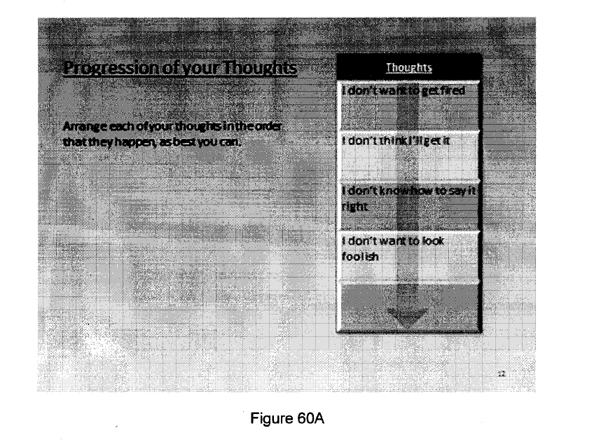

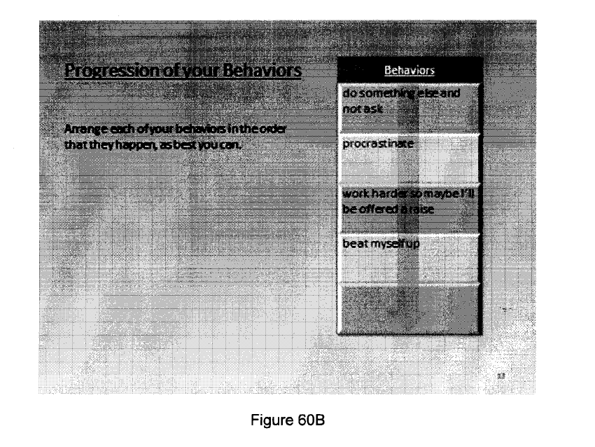

In one sequence, the GUI may prompt the user to arrange in an order a sequence of the states as they were experienced/remembered, presenting in a GUI an emotional episode. FIGS. 60A-606 are exemplary GUIs produced by an embodiment in generating outputs to order thoughts and behaviours for an emotional state from a user.

Next, the GUI may prompt the user to input a word denoting the emotion he believes to have dominated him or her during the episode and/or that he would like to change. If the provided word is not in the database, then, the GUI prompts the user to choose one or more words from those suggested which denote emotions that he believes to have dominated him or her during the episode and/or that he or she would like to change. Details of these sequences may also be stored in the database and may be associated with the record.

The GUI may present questions to have the user input states as epochs and the epochs may then be associated with the current state. Questions and answers may be stored in a database. Ancillary data from other sensors (e.g. body temperature, photoplethysmographic data, plethysmographic data, heart rate, skin temperature, eye pupil dilation size, tear duct activity, sweat level on forehead/palms, hormone levels, blood sugar level, MRI data, etc.) connected to the user at the time may be tracked and may be stored with the data. Interface prompts user to alter, modify or update emotional state vectors, as needed to user's satisfaction. Details of these questions, epochs and orderings may also be stored in the database and may be associated with the record.

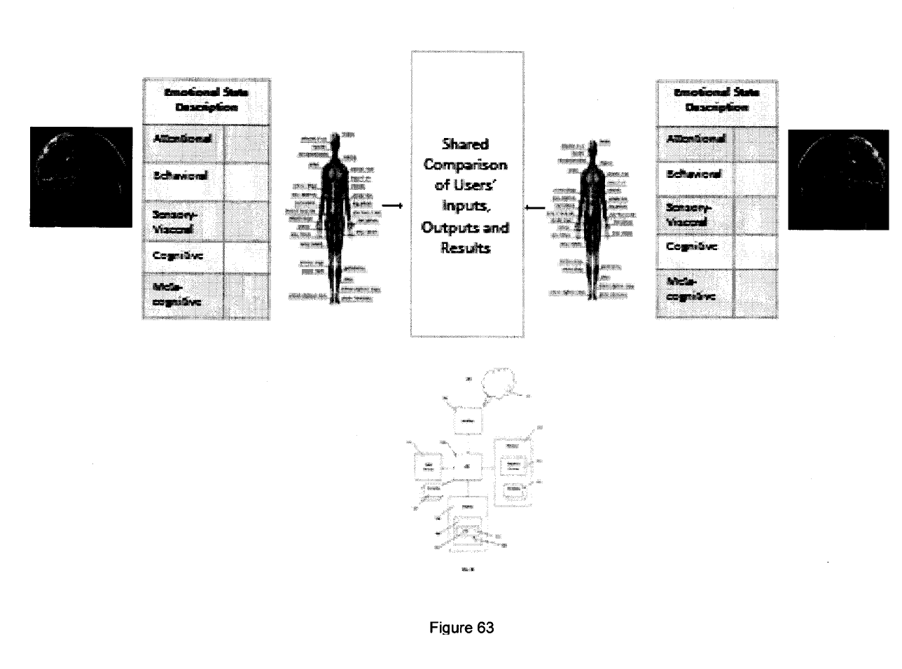

For Phase II, shown at process 102 in one embodiment, the user's text input as to his current emotional state is taken as being subjectively correct, namely if the user describes himself as currently being “happy”, then all of the state inputs as entered are mapped to that person being “happy”. As such, the record in the database may be identified as being the “happy” state for the user with the other parameters associated with it. Different types of “happy-like” states may also be entered (e.g. amused, ecstatic, etc.). Different types of “happy-like” states may be linked together in the database as having a common component (e.g. a state of happiness, contentment, satisfaction, fulfillment, etc.). For Phase II, in another embodiment, the user's text input as to his current emotional state is assessed against the B, AP, VS, C and MC data provided and against a pool of the B, AP, VS, C and MC data from a population in the database 332. If the user's self-described current state is represented by another state as provided in the population, then an embodiment may adjust the user's current state to the other state. FIG. 63 shows a block diagram of an embodiment of records in a database showing that one user's records of an emotional state may be shared and compared with records of another user's emotional states.

It will be appreciated that the database may contain records for the user for different emotional states and records from other users for their emotional states. From the population data, the database software may analyze the parameters of the user's current state record and identify a correlation of that record (using for example, values in its B, AP, VS, C and MC vector data) to other entries in the database 332. When there is a correlation of the user's state has been identified (e.g. by a sufficient matching of values in its B, AP, VS, C and MC vector data against other records), this may be taken as an indication that the user is in an emotional state that corresponds strongly to the definition of a similar emotional state by the population (e.g. other users in the database). In such a situation, the embodiment may assign the user to be in the “objective” state.

For Phase III shown at process 104 in one embodiment, a set of GUIs is provided on the system prompting the user to identify a goal (state) for the user, given his current (target) emotional state. The GUI may provide interfaces that prompt the user for a description of the target emotional episode (i.e. that which the user would like to change, delete, extirpate, de-amplify, taper or modify). The objective may be simply to not be in the current target state or to move to a specific goal emotional state. A goal emotional state may be transitioned to either from one state change (e.g. happy to calm or happy to not being happy) or through multiple states (e.g. happy to angry via calm). An embodiment may iteratively execute transition actions when multiple states are traversed. If a goal state is provided as a text description, depending on whether the user's input matches existing states in the database, the system may prompt the user for additional contexts on the goal state and refine its internal designation of a provided goal state.

Phase IV shown at process 106 in one embodiment analyzes aspects of the goal state and a desired change or transition (if provided) and identifies actions to facilitate achieving the desired change or transition from analyzing records in the database.

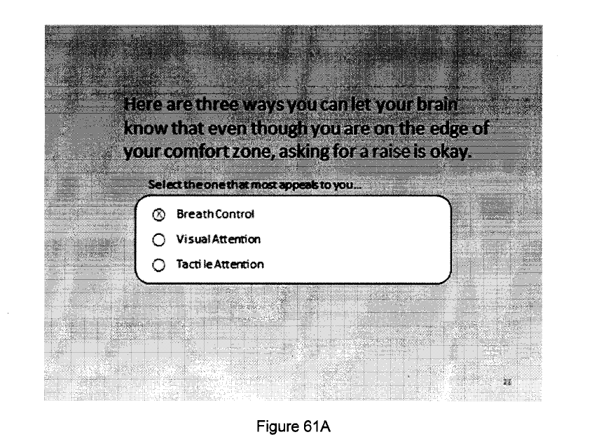

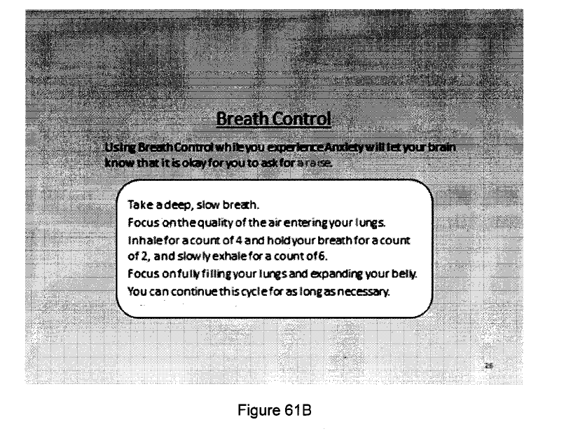

For a given state, the database may have a set of records of levers associated with it. Generally a lever record may identify an action that may be conducted by the user or a condition being experienced by the user. In the database, a link between a given lever record and a given state of user may be established. Links may be identified from experiential data for an emotion provided by the user in Phase I. A lever may be associated with an emotional state as being either enabling or disabling to the emotion. The lever record (or its type of link to the related emotion record) may reflect that association. For example, consider a database containing a record describing the emotional state of “anger” and two lever records, one for “raise blood pressure” and one for “lower heartbeat”. The database may establish a disabling link between the “anger” record and the “lowered heartbeat” record, while establishing an enabling link between the “anger” record and the “raise blood pressure” record. Each lever may also have one or more outputs associated with it to “activate” the lever. Each action may have one or more outputs associated with it, such as a message or data for a command to control an external device. For example, the “raise blood pressure” lever may have several actions associated with it, such as “exert physical activity”, “stimulate blood flow” and others. For example, in order to effect the “exert” lever, an embodiment may control an external device, such as an exercise machine, to increase the physical activity for the user and thereby activate the lever. FIGS. 61A-61B are exemplary GUIs produced by an embodiment in generating outputs to transit from an emotional state from a user.

In order to transit from a current state and/or move towards a goal state, a set of levers is identified by data processing system 300. For example, an angry state may be associated with an exemplary physiological condition of having a raised heart rate. If the objective is to not be in the angry state, then the embodiment identifies that using a lever to reduce a raised heart rate will enable the user to intervene on or interrupt the target emotional state, in this case anger. There may be multiple levers that enable the user to interrupt an emotional state.

For example, when an objective is to not be in a current target state, an embodiment identifies one or more levers associated with the current target state and for the identified levers, identifies one or more (a set of) actions that the user may take/use (as lever(s)) to intervene on or interrupt the target emotional state. Once a set of actions is identified, for each interrupting action, the lever records in the database are analyzed to identify any textual, audio and/or video files, output controls for external devices and other data that can be produced on a machine or used to control a machine that will then facilitate the user taking/using those actions in a purposive and effective way to interrupt the target emotional state. The embodiment then generates GUIs and outputs to guide and train the user to effect that interruption. For example if the interrupting action is to slow a heart rate, an associated text message may be to “press gently on the pupil of one eye for 3-5 seconds” to produce a so-called “oculocardiac response” and an associated music file of soft music may be provided. An embodiment may generate a message in a GUI to the user advising him to “press gently on the pupil of one eye for 3-5 seconds” and the soft music may be generated as an output. If the user is connected to a heart rate monitor its output may be connected to the system and the data relating to the effectiveness of the action may be provided to the user in real time or delayed time and/or recorded and analyzed by the data processing system 300.

For another example, when an objective into change or transition to a desired goal state, an embodiment identifies analyzes the database to one or more levers associated with the current target state that are statistically or otherwise positively correlated to transitioning from the particular target state to the particular goal state, either for the user or for a universe of other users' based on prior data derived from prior like or similar situations. For the lever(s) identified an embodiment identifies one or more (a set of) actions that the user may take/use (as lever(s)) to intervene on or interrupt the target emotional state and transition to the goal state. Once a set of actions is identified, for each action, the database is scanned to identify textual, audio and/or video files, output controls for external devices and other data that will facilitate the user taking/using those actions in a purposive and effective way to interrupt the target emotional state and transition to the goal state. The embodiment then generates GUIs and outputs to guide and train the user to effect that transition. For example if the identified action is to speed up the user's heart rate, an associated text message may be to “breathe quickly” and an associated video of a race may be provided. An embodiment may generate a message in a GUI to the user advising him to “breathe quickly” and the video music may be generated as an output. If the user is connected to a heart rate monitor its output may be provided to the user in real time or delayed time and/or recorded and analyzed by the data processing system 300.

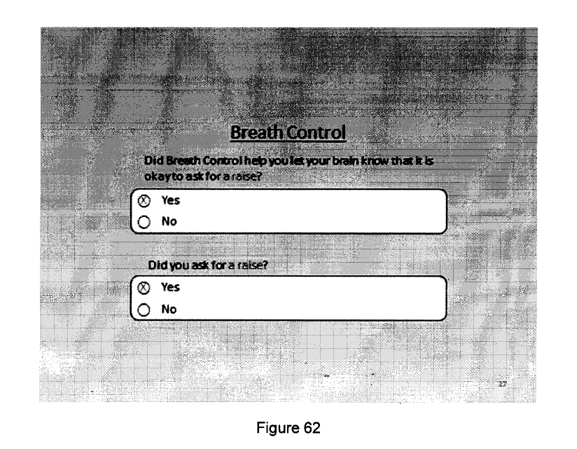

After the GUIs and outputs are generated, an embodiment may present additional GUIs asking the user to correlate his current emotional state against the desired change. To the extent there are deviations from the subjective or objective states (tracked in the database), the information may be used to refine the database entries. It will be appreciated that the four phases may be combined and/or executed in different orders as needed and additional phases may be added to enhance the usability and effectiveness of the system and method. FIG. 62 is an exemplary GUI produced as an output soliciting an input from the user for feedback.

Now, more details on processes in FIG. 1C(i) are described in FIG. 1C(ii). A method of an embodiment utilizes a mapping by the subject, under the guidance of a program executing on a machine that generates a user interface, of one or more target emotional states, in terms of the behavioral, attentional-perceptual, sensory-visceral, cognitive and meta-cognitive states that together constitute the emotion in question. The target emotional state is an emotional state that subject would like to change, delete, extirpate, de-amplify, taper or modify. It may be a counter-productive emotional state—one that produces personal or interpersonal results that are deleterious to the goals or objectives of the person. The set of emotional states that the portrait maps may include states that are referential (“I am angry at you”), responsive (“I am sad because you are unhappy”), or reactive (“I am afraid because you are enraged”) to the states of another person towards whom, or on account of whom, the subject experiences his emotional state. Mapping an emotional state proceeds by first mapping an emotional episode—or, an episode in which that emotional state was instantiated by or in the subject. Table 1 shows a typical mapping of an emotional episode for a user, which may be stored in a database and accessed by the database system. The user's emotional state at any point in time is defined by the set of behavioral, attentional-perceptual, sensory-visceral, cognitive and meta-cognitive states associated with that emotion. In particular, Table 1 shows a five-dimensional mapping of an emotional episode, where states are listed across the top and distinct times (“epochs”) are listed in corresponding rows. Entries in the tables reflect a current feeling/sensation for a state at a given epoch. Entries are text entries provided by a user in one embodiment. In another embodiment, additional entries may contain a measured physical condition of the user (e.g. heart rate, body temperature, etc.). The mapping of an emotional episode is broken up into time quanta or epochs and the subject is asked to supply details on each epoch. The duration of epochs may vary between approximately 5 seconds and 10 minutes, and is adjustable by the subject inside and outside this range based on the subject's circumstances. These epochs provide discrete discernible or distinguishable periods of time that may be indexed to distinct behavioral, attentional-perceptual, sensory-visceral, cognitive and meta-cognitive states of the subject. The mappings disclosed here do not require completeness in the specification of all of the states associated with an emotional state or sequence of states. The subject is asked to provide as much input as possible on the content of his emotional states. An emotional state may take up several epochs of a table that describes an emotional episode.

TABLE 1
Phenomenological (B-AP-VS-C-MC) Portrait of Emotional State

| | | | | |
|---|---|---|---|---|
| | | | | What I |
| What I | | What I | | thought |
| said or | | perceived | | regarding |
| did | What I | or attended | What I | how I felt or |
| (B | thought | to | sensed | thought |
| plane) | (C plane) | (AP plane) | (VS plane) | (MC plane) |

Epoch 1
Epoch 2
. . .
Epoch n

Table 2 shows a typical mapping of an emotional state which includes details of the person towards whom that emotional state is directed. In particular, Table 2 shows an adaptation of B-AP-VS-C-MC portrait of the emotional episode for an interpersonal situation.

TABLE 2
Adaptation of B-AP-VS-C-MC Portrait of Emotional State for Interpersonal Situation

| | | What I | What I | | What I | What I | What I |
|---|---|---|---|---|---|---|---|
| | What I | thought but | perceived and | What I | thought he | felt he | thought |
| | said or did | did not say | attended to | sensed | thought | felt or | regarding what |
| | (B plane) | (C plane) | (AP plane) | (VS plane) | (interpretation) | sensed | I thought |
| Epoch 1 | | | | | | | |
| Epoch 2 | | | | | | | |
| . . . | | | | | | | |
| Epoch n | | | | | | | |

For example, a representation of the emotional state fear may be represented in the B-AP-VS-C-MC system as follows. In particular, Table 3 shows an exemplary phenomenological B-AP-VS-C-MC portrait of an emotional episode for the emotion fear for a user.

TABLE 3
Phenomenological, B-AP-VS-C-MC Portrait of Emotional State FEAR

| | | | | | What I |
|---|---|---|---|---|---|
| | | | | | thought |
| | | | What I | | regarding |
| | | | perceived | | how I felt |
| | What I | What I | or | What I | or thought |
| | said or did | thought | attended to | sensed | (MC |
| | (B plane) | (C plane) | (AP plane) | (VS plane) | plane) |
| Epoch 1 | Fidgeting, | I may be | Doorway in | Tightening | I cannot |
| | rubbing | fired for | front of me, | of jaw, | be |
| | neck with | this . . . | | furrowing of | thinking in |
| | hands | | | eyebrows, | this way |
| | | | | urination | |
| | | | | impulse. | |
| Epoch 2 | Pacing | I will not | White walls, | Quickening | . . . |
| | | be able | ceiling. | of pulse, | |
| | | to | | increased | |
| | | recover | | speed of | |
| | | . . . | | inspiration, | |
| | | | | freezing | |
| . . . | | | | | |
| Epoch n | | | | | |

As another example, a state of contempt towards another person in the context of a conversation may be represented as follows. In particular, Table 4 shows a phenomenological B-AP-VS-C-MC portrait of the emotional state of contempt.

TABLE 4
Phenomenological, B-AP-VS-C-MC Portrait of Emotional State CONTEMPT

| | | What I | What I | | What I | What I | What I |
|---|---|---|---|---|---|---|---|
| | What I | thought but | perceived and | What I | thought | felt he | thought |
| | said or did | did not say | attended to | sensed | he thought | felt or | regarding what |
| | (B plane) | (C plane) | (AP plane) | (VS plane) | (interpretation) | sensed | I thought |
| Epoch 1 | You are | And you show | Blank stare | Faster | I am not sure | Fear and | I cannot help |
| | incapable of | no signs of | of X at the | heart rate, | where this all | anger | but think |
| | understanding . . . | understanding | void just | shallow | came from . . . | | this way, |
| | | this, either | behind me | breathing | | | given . . . |
| Epoch 2 | | | | | | | |
| . . . | | | | | | | |
| Epoch n | | | | | | | |

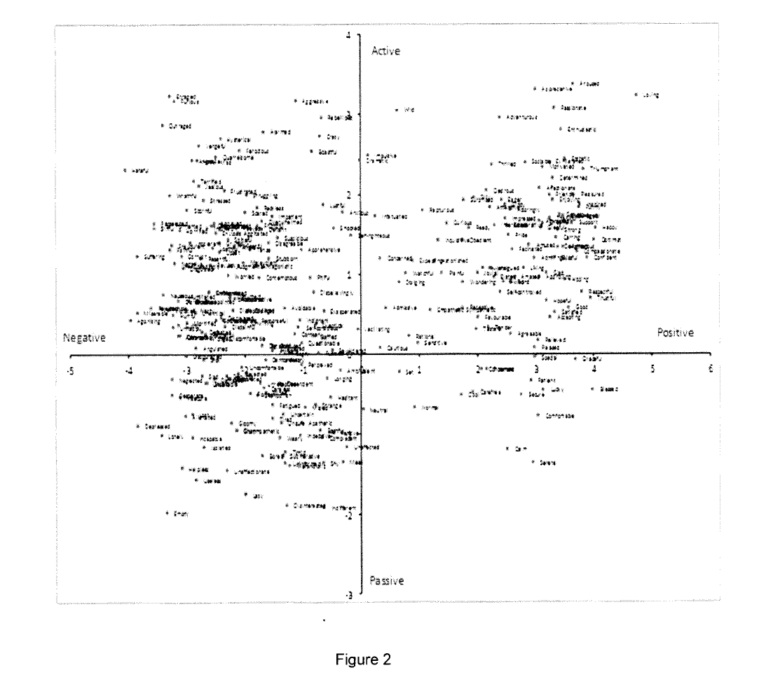

FIG. 2 shows a map of the human emotions rated as a function of relative activity/passivity and positivity/negativity.

Now further detail is provided on features of an embodiment that refine the experiential data provided by a user. After providing a mapping of an emotional episode that makes the experience of that episode sufficiently vivid to the subject, an embodiment provides facilities that present questions to the subject to identify one or more emotions that he believes to have dominated him during the episode. It may also ask if he would like to transition from that emotional state to a specified goal emotional state or to an unspecified emotional state.

In one embodiment, a map of identifiable emotional states is presented either graphically or textually to the user. An exemplary graph is shown in FIG. 2. Therein, emotions are represented in terms of the degree of their activity-passivity (on the y-axis) and negativity-positivity (on the x-axis), based on data provided from a number of subjects. As such, each emotion can be assigned a value in terms of one or both of its activity-passivity and negativity-positivity (e.g. on a numeric basis for each axis). This enables records of emotions to be ranked and grouped in the database. For example a class of emotions may be defined in the database encompassing emotions that are within a defined range of activity-passivity and/or negativity-positivity scores (e.g. a “happy” class of emotions may include “joyous”, “giddy” and other states that have positivity scores over a certain value and within a certain range). Clearly, different people may rate their own emotional states differently in terms of degrees of activity-passivity and positivity-negativity. The map of FIG. 2 provides an initial estimate of mapping of states along these dimensions. In one embodiment, each user may also construct his own emotional state map, representing the emotions that he deems relevant, and may modify ranking of emotional states from time to time along the axes of positivity-negativity and passivity-activity according to his subjective estimate.

For one embodiment, boundaries between epochs in the portrait of an emotional state are left to be defined by the subject, who is prompted to specify them. However, one embodiment provides a “training sequence” wherein the user is prompted to identify more accurately discernible epoch boundaries and co-locate the B-AP-VS-C-MC components of an emotional state. Because the epochs contain co-occurring time slices of an emotional state (“I thought X while seeing Y while sensing Z”), a fuller portrait of the emotional state may comprise sequences of parallel B-AP-VS-C-MC impressions. The co-location of the B-AP-VS-C-MC components of an epoch—the identification of these states as being simultaneous or co-occurring in the same period of time—provides precision to defining an emotional state. The compilation of an emotional state table based on multiple epochs pertaining to an emotional episode may be problematic because of problems of imperfect recall of the subject of the precise co-location of the different components of an emotional state. A subject may report a set of visceral reactions (sweaty palms) and thoughts (self-blaming ideation) that did not, in fact, occur simultaneously, or were even closely co-located in the same epoch.

For this reason, an embodiment provides a “training sequence” wherein a user may be provided with teaching mechanisms through GUIs to more accurately introspect and identify and record his behavioral, attentional-perceptual, sensory-visceral, cognitive and meta-cognitive states. In an exemplary training sequence, a user may be videotaped in an activity or interaction, then may watch a “strobed” copy of the video record, which is broken up into epochs (of duration ranging from seconds to minutes, selected by the subject; or, in one other embodiment, chosen randomly by the program that controls the interface to the subjects). The subject then may describe a set of components (B-AP-VS-C-MC) associated with the emotional state that occur during each epoch. Over repeated practice of the strobed description exercise, the subject may learn to more precisely define and describe the emotional state that inheres in each epoch. The training sequence may be used whenever the ability of a subject to precisely recall and describe his emotional states is in doubt or whenever an improvement in that particular ability is sought. For instance, improving the distinguishability of emotional states on the basis of his co-occurring B-AP-VS-C-MC components may be achieved by decreasing the duration epochs (or, increasing the “strobing frequency”) over which self-reporting and introspective description of the subject's emotional states is sought.

At the end of “Mapping I”, the subject has created a five-dimensional portrait of an emotional episode representative of a life pattern that he would like to change, and chosen an emotional state that he believes is causally implicated in the production and maintenance of that pattern. This portrait of the episode is stored as a record in the database.

“Mapping II” refers to neurophysiological mapping, where the subject is led through a process of building a neurophysiological map of his target emotional state. The neurophysiological mapping of a target emotional state is based on the subject with a brain map and a body map that guides him to the brain and other body and organ system structures and functions involved in the production of the target emotional state. The exposure protocol introduces the subject to (a) the brain and other neural structures involved in producing the B-AP-VS-C-MC components of the target emotional state (herein identified as a Brain Map) and (b) the body and organ system structures (e.g., endocrine, cardiovascular, etc.) (herein identified as a Body Map) involved in producing the effects that the subject associates with the target emotional state.

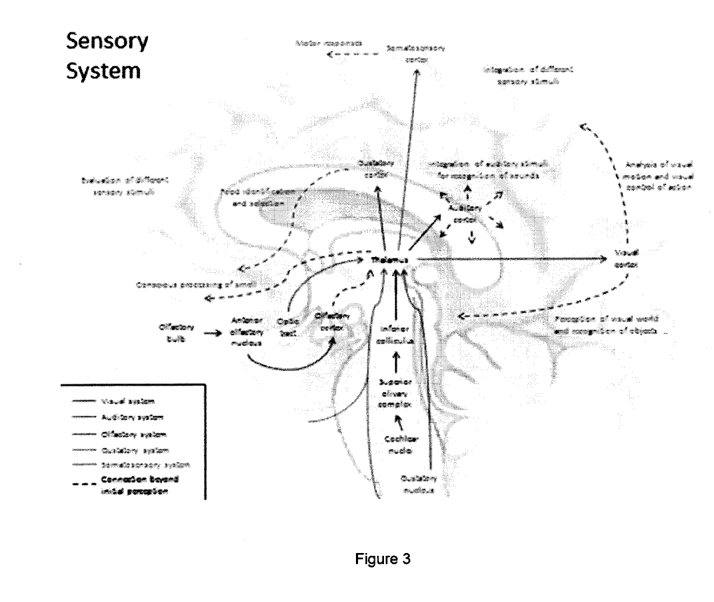

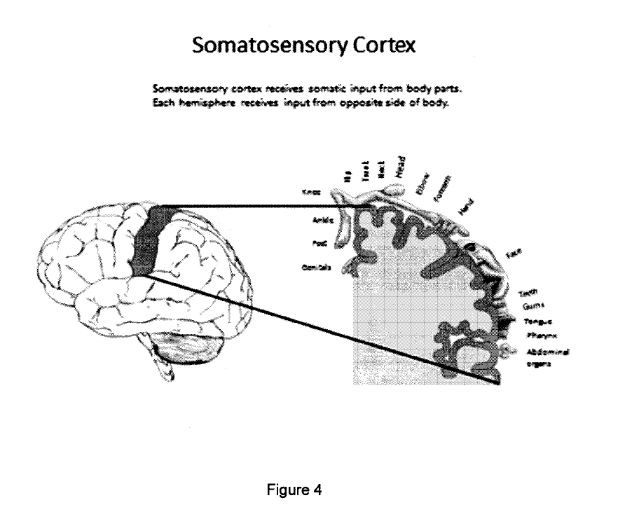

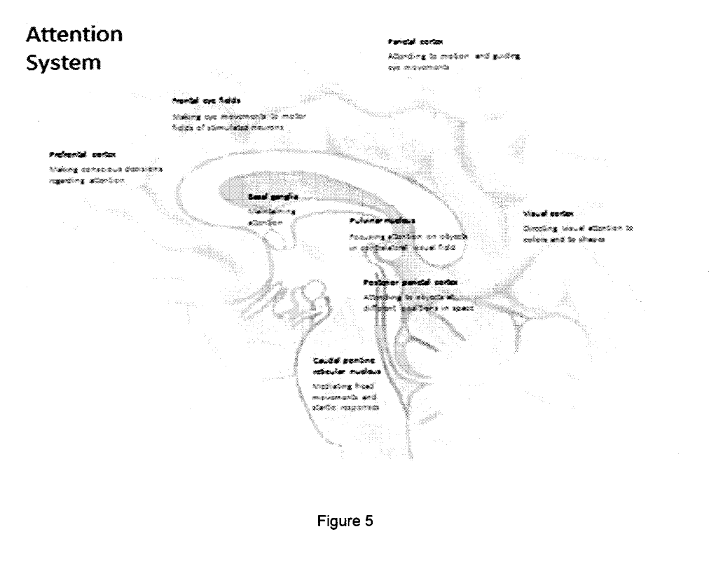

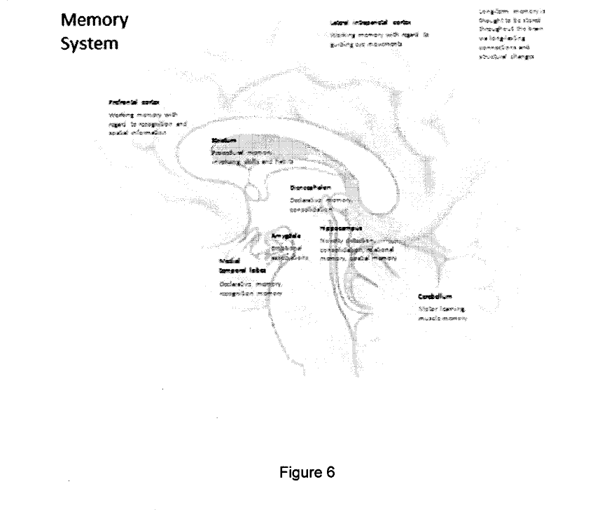

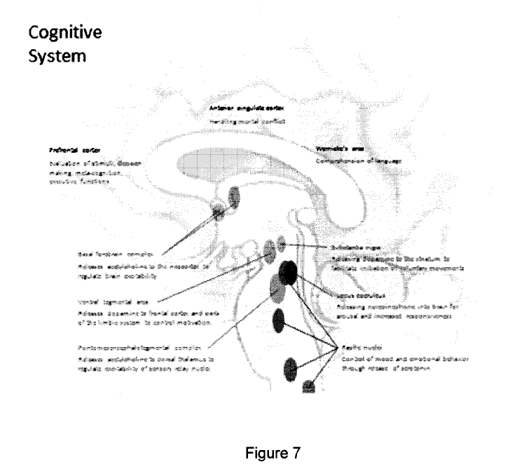

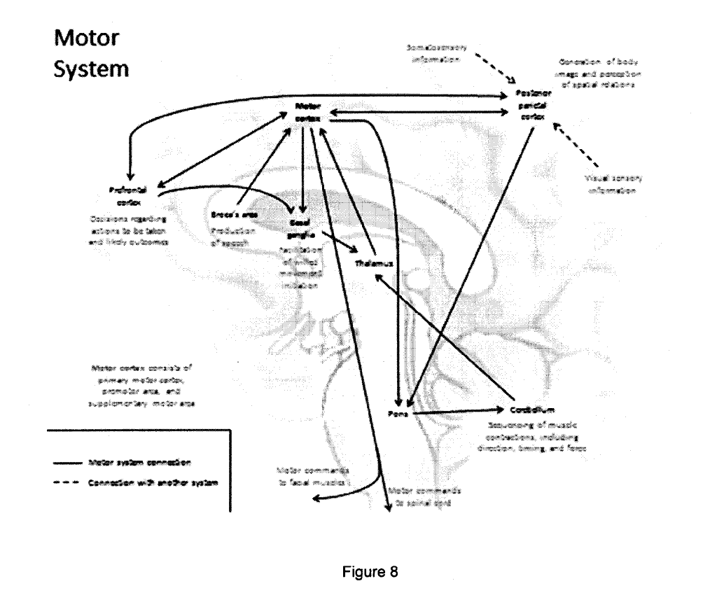

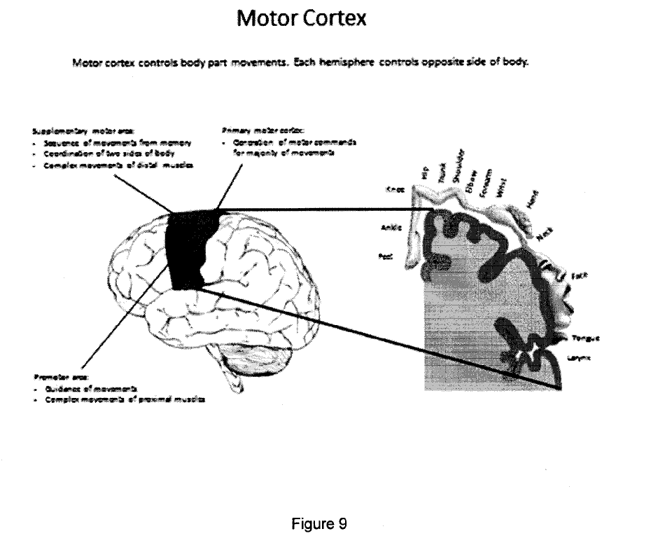

An aspect for Mapping II is to produce outputs that guide the subject to build a neurophysiological model (“NM”) of the phenomenological states (“PS”) associated with a particular target emotional state, which, in turn, allows him to see the links between his cortical and physiological responses and the emotional phenomenology embedded in the phenomenological portrait of an emotional episode. As an emotional state is constituted in an embodiment by the five-dimensional phenomenological portrait of that emotion, being able to change one or more components of the portrait should also produce changes in the emotional state. The subject is guided to produce changes in the B-AP-VS-C-MC components of an emotional state on the basis of a brain map and/or a body map that associates specific structures, mechanisms and responses to each one of the states, then the subject is able to achieve a volitional or purposive modification or transformation of his emotional state, by interacting directly with the causal mechanisms and relations mapped in the brain map and body map of the emotional state. For reference, in an embodiment the subject is provided with a physiological-structural map of the human brain (see FIGS. 3-9) and of his peripheral nervous system. These maps are provided as background only. Specific brain maps and body maps of specific target emotional states are used in the guiding phase to offer the subject specific guidance on modifications or transformations to his emotional states on the basis of executable action sequences that are derived from the brain map and the body map for each specific emotional state.

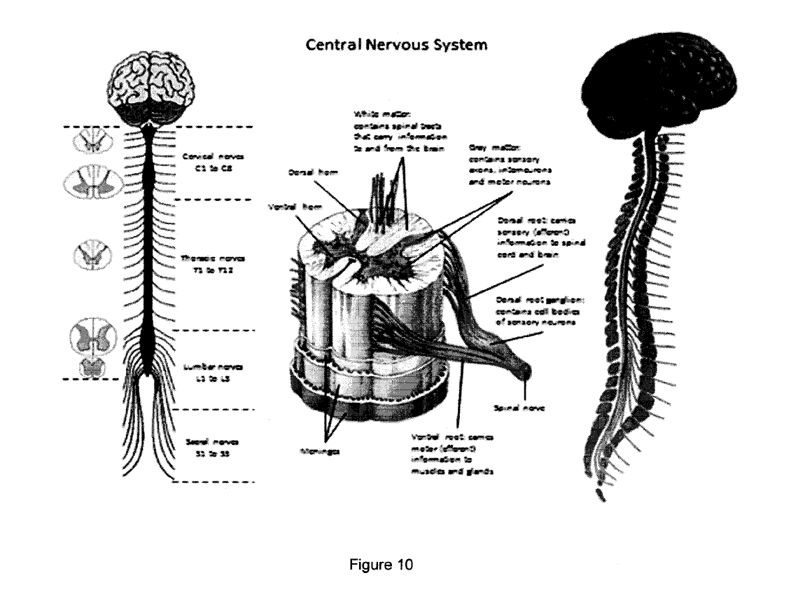

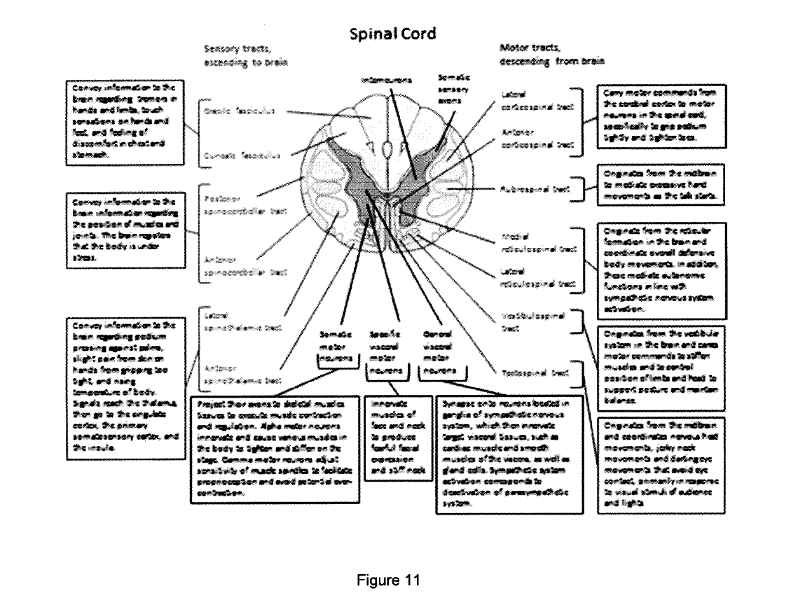

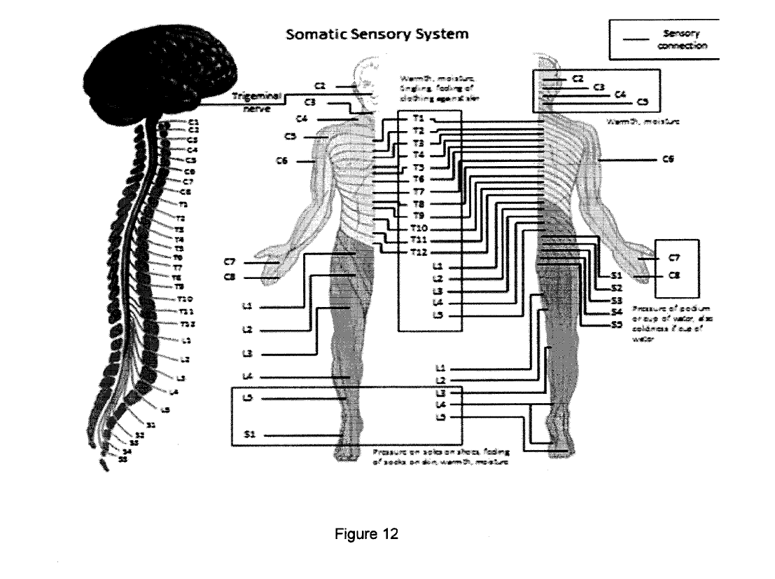

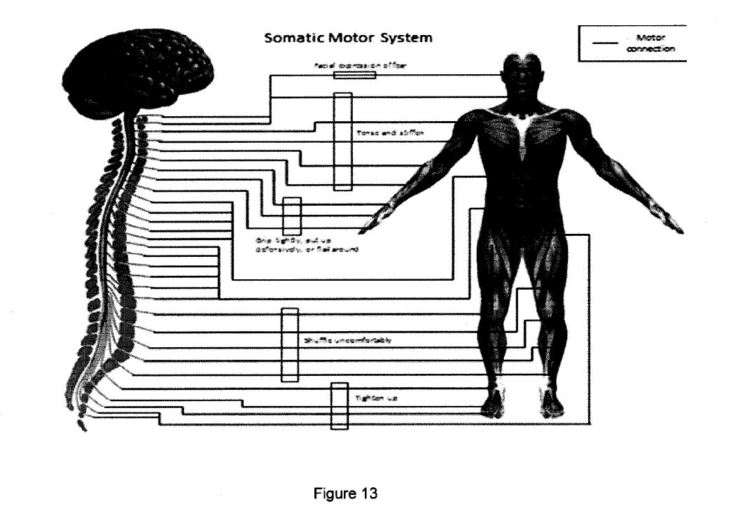

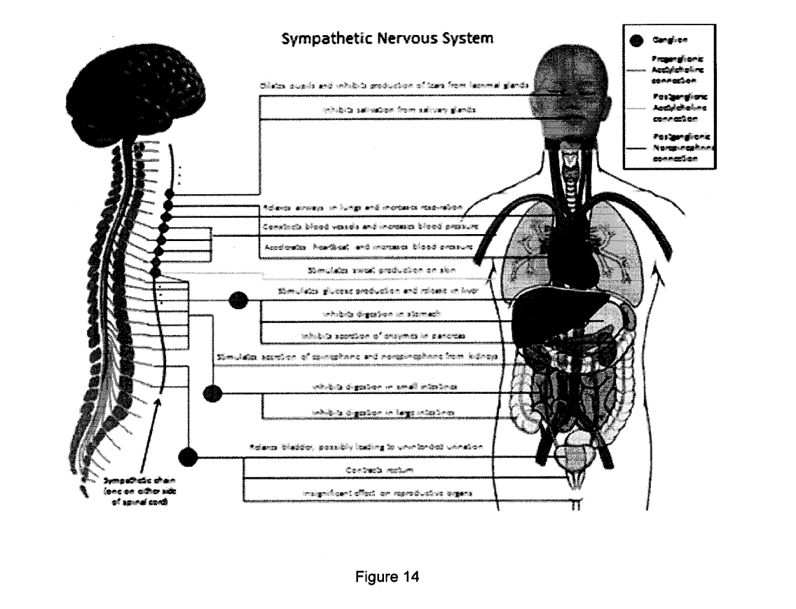

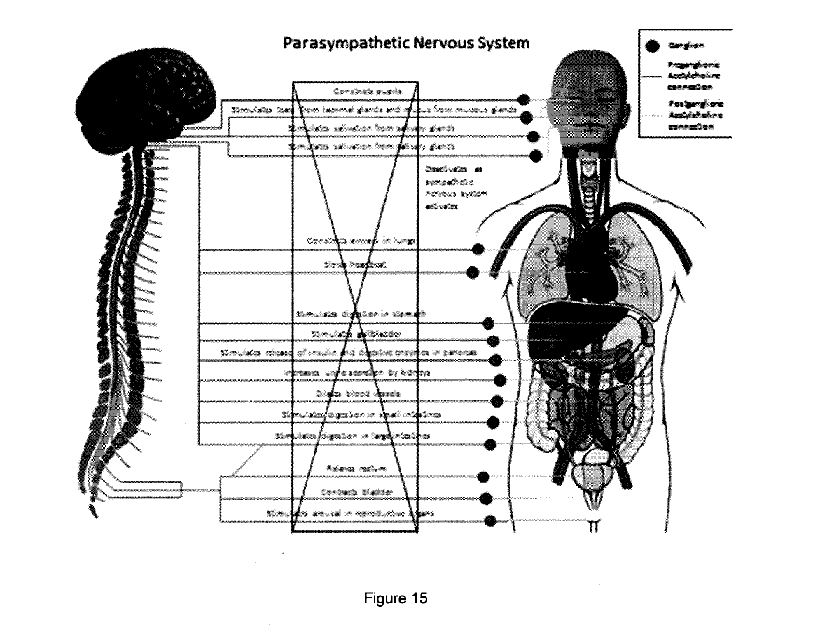

FIGS. 3-9 show functional brain maps, indexed to specific components (B-AP-VS-C-MC) of the experience that the subject has of an emotional state. FIGS. 10-16 show functional body maps for neurological and physiological responses associated with emotional states.

At the end of Mapping II, an embodiment has constructed a neuro-physiological model of the phenomenological portrait of his target emotional state. This is referred to as a neuro-phenomenological (“NP”) model of the subject's emotional state.

A “Guiding” phase is now described. According to an embodiment, outputs are generated to guide the subject to a set of levers that are likely to either modify or transform the target emotional state to an unspecified state (unsupervised learning) or modify or transform the target state to a specified goal state (supervised learning).

“Guiding I” refers to a design and selection self-regulation levers in the following.

A first step of the guiding phase according to one embodiment comprises a process by which the subject is offered a selection among a set of levers by which he may either transition from his target emotional state to some other, unspecified state, or by which he may transition from his target emotional state to a goal emotional state. A self-induced emotional state change lever is an accessible action that may be performed by the subject which is likely to change one of more components of the subject's emotional state vector by changing the underlying neuro-physiological and physical state of the subject. A system and method of an embodiment computes a set of self-change levers on the basis of the brain and body maps associated with specific emotional states. These levers are prompts, by the subject, to his brain. Hence, the disclosure discloses a mind-brain interface, a protocol by which the subject may interact with his brain to produce targeted changes in its states.

For example, the subject may choose to intervene on his visceral-sensory states by wilfully decreasing the frequency of inspiration (counteracting the self-amplificatory effects of the activation of the sympathetic nervous system), or by pressing on the pupils of his eyes (inducing a lowering of the heart rate via the oculocardiac response). Alternatively, the subject may choose to intervene on his attentional-perceptual states by focusing his gaze on a specific point in space that has neutral or positive valence, thus counter-acting the effects of ruminative-obsessive thoughts and images on his emotional state by removing the afferent signals into his limbic system that trigger a stress response or the more complex fear response. Alternatively still, the subject may choose to intervene at the level of his meta-cognitive states and focus on registering and remembering the thoughts, perceptions and visceral-sensory signals that constitute the emotional state, once again disengaging the aversive input signals (threat stimuli) from the set of perceptual inputs to the limbic system.

In an unsupervised self-change embodiment, the subject selects a set of levers that are derived from a set of defined neurophysiological structures and mechanisms (represented in a Brain Map and a Body Map of the target emotional state) known according to current research to produce changes in one or more components of the phenomenological state vector corresponding to the target emotional state.

In a supervised self-change embodiment, the subject constructs a B-AP-VS-C-MC state vector for a goal—or desired—emotional state, and selects a set of levers that are likely to produce a transition from the target state to the goal state, i.e., the subject attempts to choose levers that minimize the difference between the state vector representing a target emotional state and the state vector representing the goal emotional state.

At the end of the first step of the guiding phase of the method, the subject is in the possession of a set of neurophysiologically plausible set of levers for self-directed emotional state change—i.e., a set of executable actions that induce a measurable set of changes to the phenomenological state vector corresponding to a target or a target and goal emotional state.

“Guiding II” refers to features of an embodiment providing actuation and iterative self-regulation. According to one embodiment, the subject proceeds to use the set of levers attained at the end of the first step of the guiding phase of the method to actually produce changes in the state vector associated with an emotional state, in either a supervised manner, or goal-state-directed, or unsupervised, or, non-goal-state-directed, manner. For an embodiment, the actuation step has two components: a dry-run and a live-run.

In an embodiment of the dry run component, the subject attempts to modify or transform an emotional state that is low in intensity (towards the passive end of the active-passive spectrum) but slightly negative in valence to another, unspecified emotional state, or to a goal emotional state that is also low in intensity but slightly positive in valence, by first mapping the phenomenological and neuro-physiological states associated with one or both of these states, and then attempting to actually modify or transform his emotional state by the self-initiated use of the chosen lever or set of levers. This part of the actuation step of the guiding phase is called “dry run” because it involves a relative “easy” self-directed emotional modification or transformation task, involving only a low-intensity emotional state, and a small difference between the intensity levels of the target state and the goal state. The subject records over a period of time ranging from minutes to days, the results of the dry run case, and makes iterative and sequential adjustments to the lever or set of levers that he has attempted to use to effect self-directed emotional modifications or transformations.

In an embodiment of the live-run component, the subject attempts to modify or transform his target state to either an unspecified state or a specific goal state starting from an identified target state that is low in valence (high negativity) and high in activeness—such as fear, disgust or rage—by first mapping the phenomenological states with the associated neurophysiological states and mechanisms, selecting a set of levers for phenomenological state changes that are supported by neurophysiological structures and mechanisms, and then actually using the levers in an attempt to produce the desired modification or transformation of the emotional state. The subject records, over a period of time (which may range from minutes to days) results of a live run case, updates his set of levers, as well as the Brain Map and the Body Map that he has produced for the target emotional state and makes iterative and sequential changes to the set of levers that he has attempted to use to effect self-directed emotional state changes.

By the end of the guiding phase in an embodiment, the subject is in the possession of a set of levers for emotional state modification or transformations that preferably produce the changes in the emotional state vectors associated with a target state, in either unsupervised (no goal state) or supervised (goal state) regimes. These levers are (a) actionable—the subject may affect them while in the target emotional state and (b) causal—they are known to effect changes in the brain map and body map of an emotional state. By exercising the use of these levers, the subject learns to effect volitional control over his target emotional state by exercising volitional control over his brain states and body states associated with the B-AP-VS-C-MC components of the target emotional state.

“Guiding III” refers to iterative optimization and entrenchment in the following.

According to one embodiment of the disclosure, the final step of the guiding phase involves the adaptive, feedback-based patterning and imprinting of the set of self-directed, lever-based changes, aimed at fine-tuning, rehearsing and entrenching the preferably maximally efficient set of levers for either (a) changing a target emotional state vector to an unspecified emotional state vector that is markedly different from the target state vector, or (b) changing a target emotional state vector to a specified, goal emotional state vector. Over a period of days to years, the subject iteratively and sequentially practices using the levers and/or sets of levers that he has synthesized at the end of the previous process (Guiding II) to improve the reliability and efficiency of the self-directed emotional state transition processes that the subject has designed. The subject also tracks—via an electronic interface to the system 300—a reliability with which he may produce self-directed changes in his emotional states to either an unspecified state or a goal state (measured as the proportion of times in which the self-directed changes using the selected set of levers were successful at producing a change in the subject's experience and/or as measured by one or more devices intended to measure such changes) and the efficiency with which the emotional state change was produced via the use of these levers (measured via the inverse of the characteristic time constant of a self-directed state change or other measures). The disclosure provides for a lever-usage-tracker that takes as input from the subject the set of levers that he has actually used to bring about an emotional state change, and the subject's estimate (e.g. on a Lykert scale of 1-7) of the success that the subject has registered in the usage of the levers to bring about the emotional state change.

One embodiment provides facilities to receive input data, process the data and produces outputs to assist a subject to transition out of the emotional state fear by changing the specific cortical and physiological responses associated with it, on the basis of an underlying brain map and body map of the emotional state. Further details on changing from exemplary states are described below.

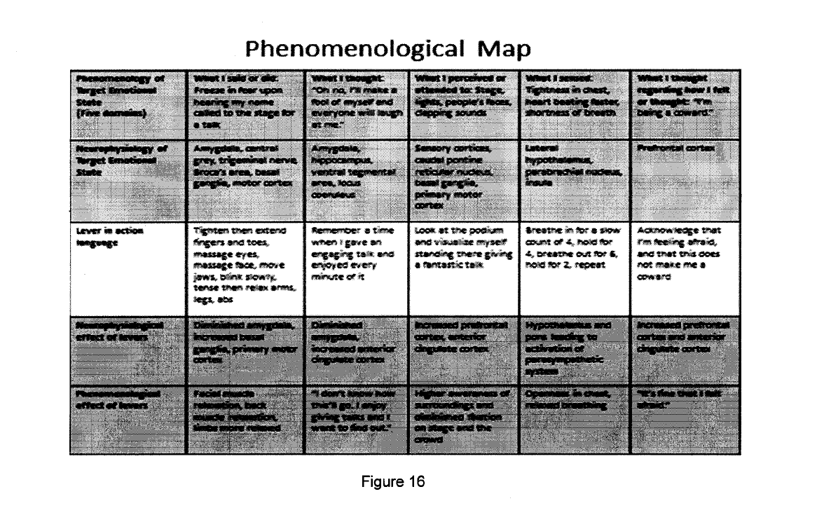

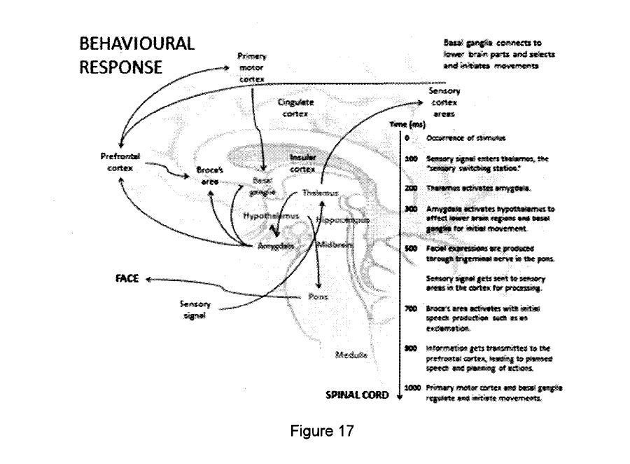

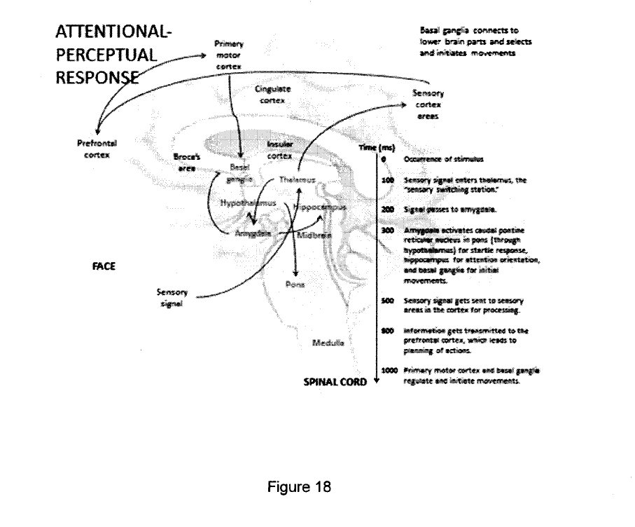

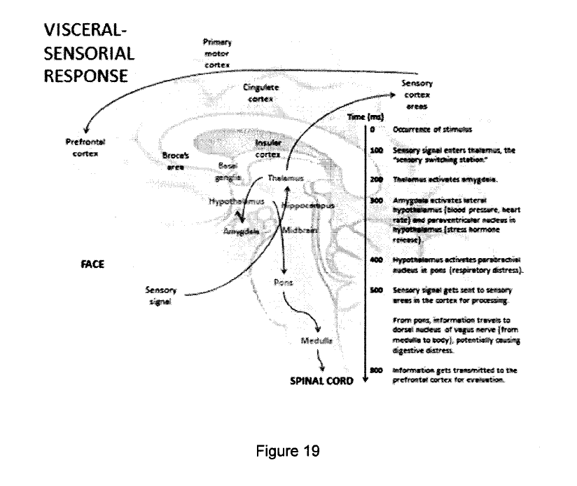

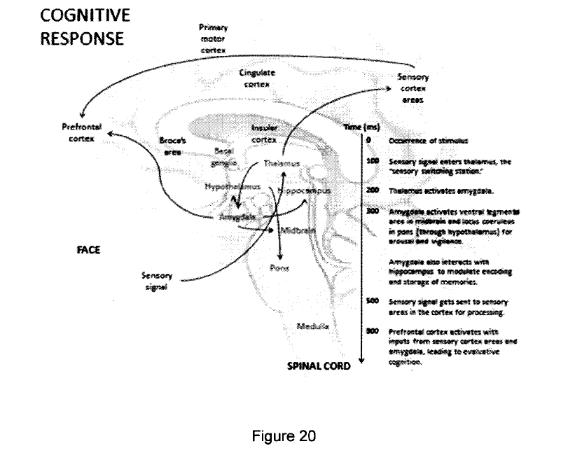

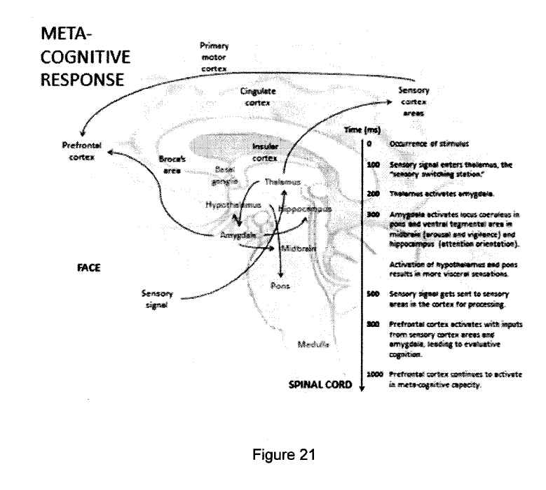

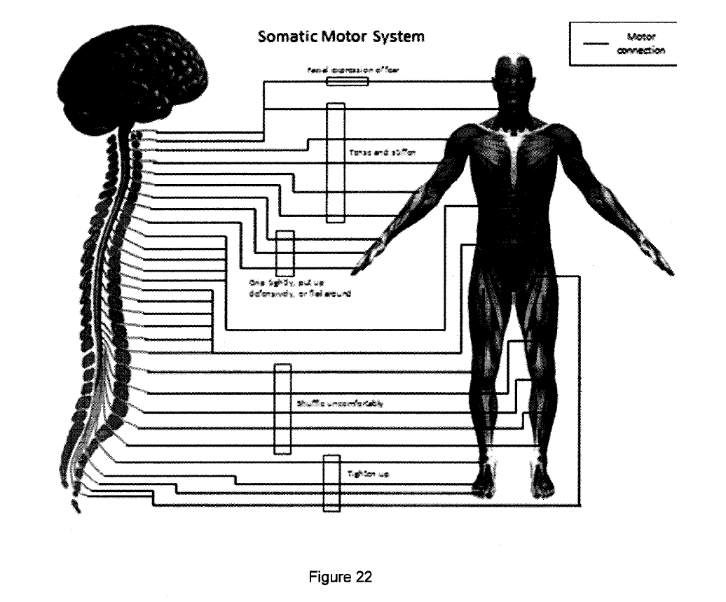

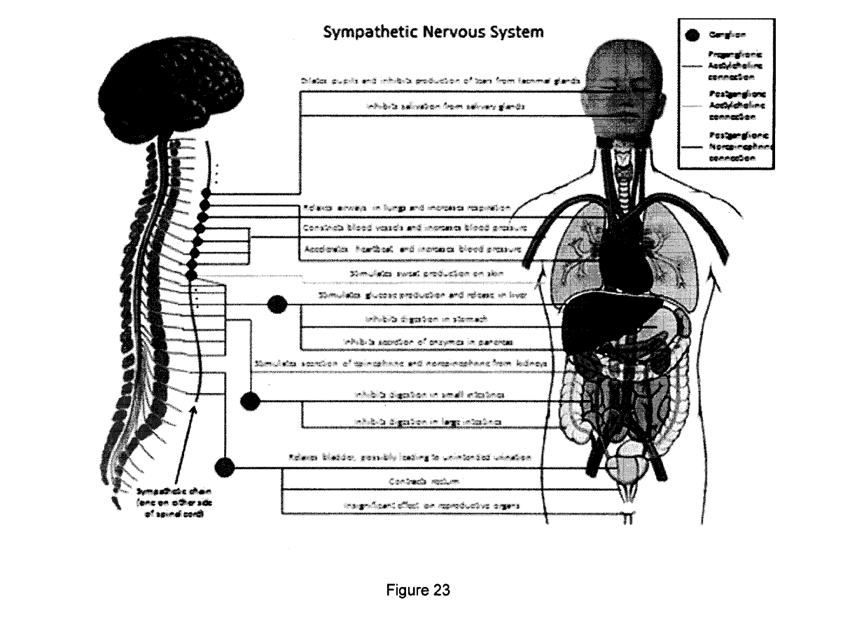

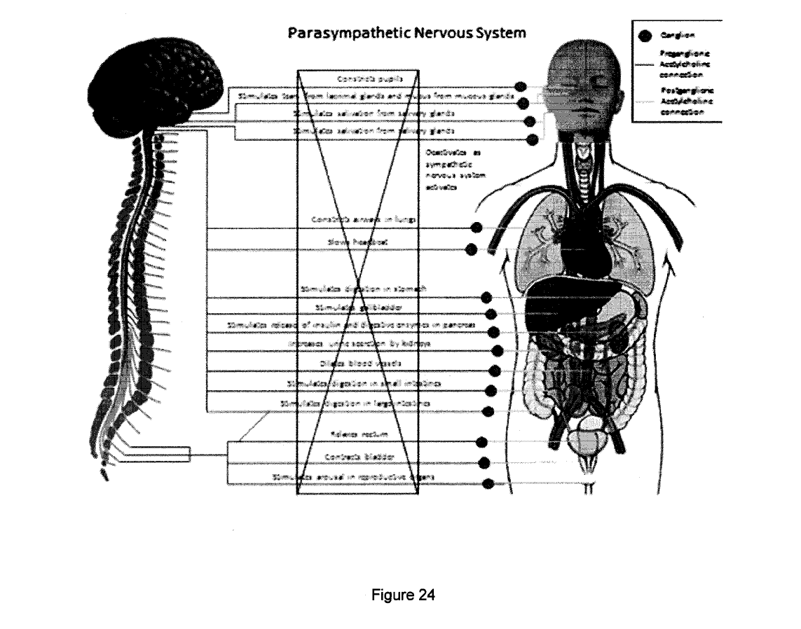

FIG. 16 shows a table of actions that a user may initiate to produce a change for the emotional state fear as it arises in a specific emotional episode. FIGS. 17-21 show brain maps for neurophysiological correlates of the fear state. In each of FIGS. 17-21 a series of responses are shown (as arrows) as they pass through various parts of the brain. A timeline shows the progression of each response for the fear state. FIGS. 22-24 show body maps for neurophysiological correlates of the fear state. It will be appreciated that sensitive input devices (e.g. RT fMRIs) may be able to provide data showing brain patterns for the fear state as a response progress through parts of the brain. Other devices (e.g. heart rate monitors) may provide inferential data relating to those responses. As such, an embodiment has discrete data on a subject's responses that may be used to detect when fear is being felt by the user. The text of the responses and the timelines of FIGS. 16-24 are incorporated into this specification.

For an embodiment, mapping of an emotional state currently experienced by the user may be achieved by presenting a series of GUIs to the user asking for descriptions of current feelings. From the text data provided by the user, a map of the attentional-perceptual, sensory-visceral, cognitive and meta-cognitive states associated with his response (FIG. 16) is created. A computer system, using an associated database, then computes and displays to the subject a set of brain maps and body maps such as those associated with the fear emotional state (see FIGS. 17-21 and FIGS. 22-24).

As an example, an embodiment provides a data relating to a Brain Map, representing a neurophysiological pattern or signature (a ‘brain pattern’) against different stimuli. A subject can see specific physiological effects of a specific emotional state. For example for a fearful stimulus (e.g. a propositional thought, an image or some other sensory signal) in the amygdala, the subject (consciously or subconsciously) activates the sympathetic nervous system (causing faster heart beats, perspiration, paleness, pupil dilation and the elevation of blood pressure) via the lateral hypothalamus, activates the parasympathetic nervous system (causing higher levels of gastric juice secretion, urination impulses) via the dorsal motor nucleus of the vagus nerve, activates the parabrachial nucleus (causing increased respiration i.e. faster breathing), activates the release of dopamine, norepinephrine and acetylcholine (causing arousal, increased vigilance) via the ventral tegmental area, the locus coeruleus and the dorsal lateral tegmental nucleus, activates the nucleus reticularis pontis caudalis (causing increased startle response), activates the central grey matter area (causing the sensation of freezing), activates the trigeminal and facial motor neurons (causing furrowing of the brows, opening of jaws) and activates the release of adeno-corticotropic hormone by the pituitary gland under the influence of the hypothalamus, which in turn causes the release of corticosteroids (cortisol and glucocorticoids) from the adrenal cortex, which are causally implicated in stress response signs (such as choppiness of attention and thought and increased irritability).

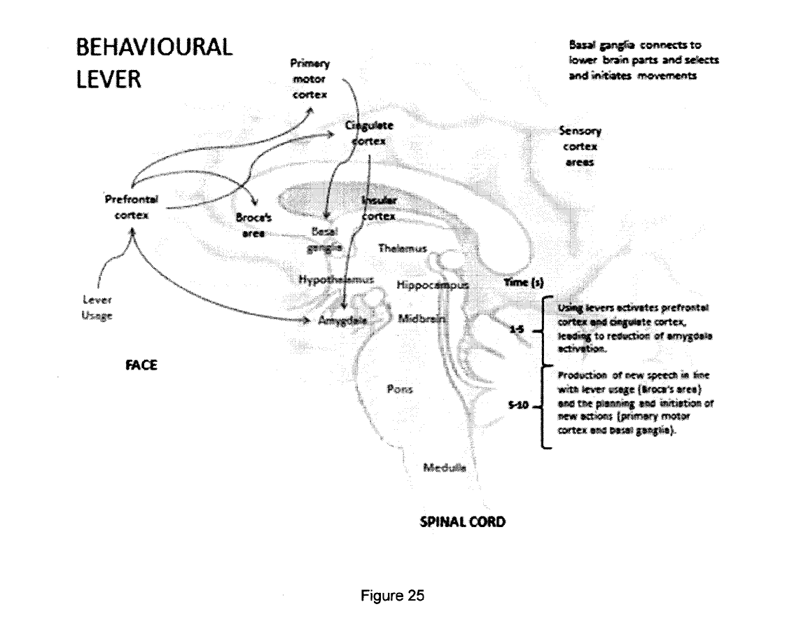

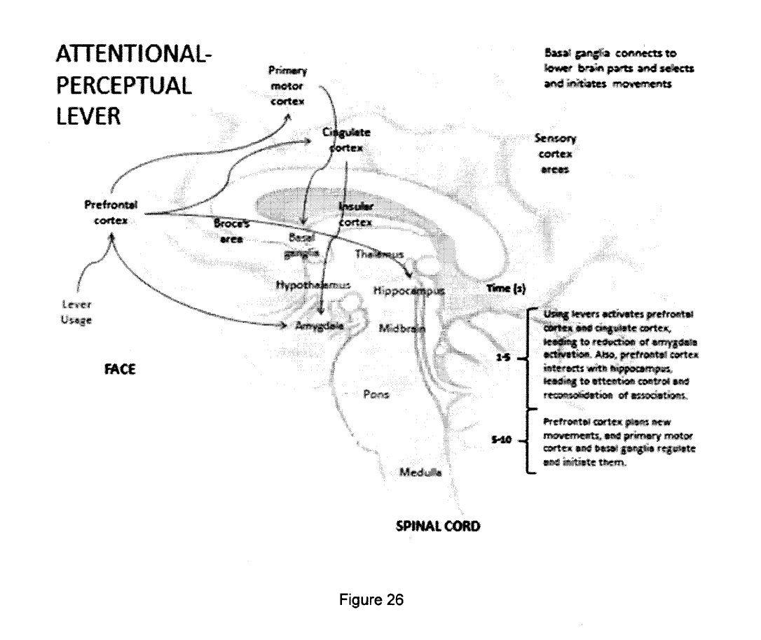

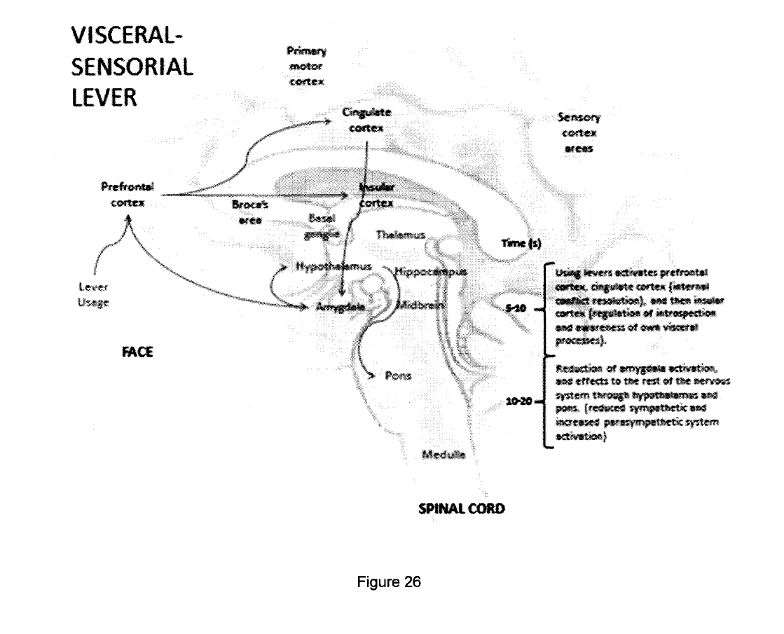

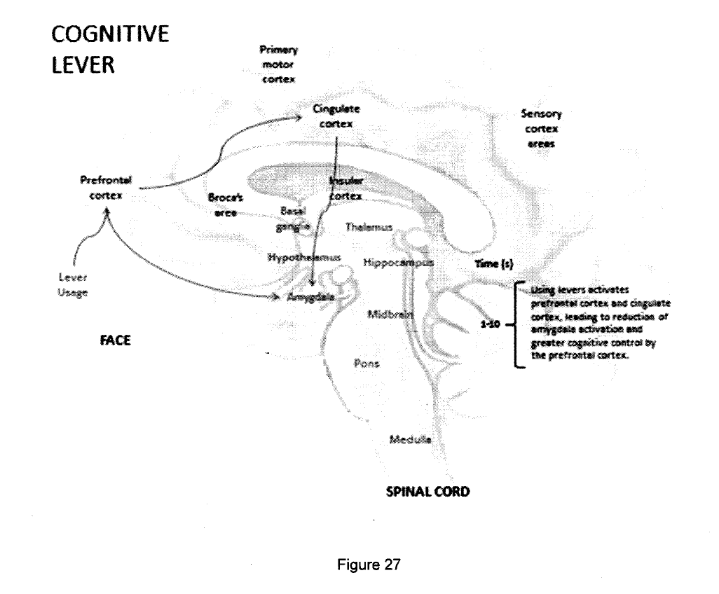

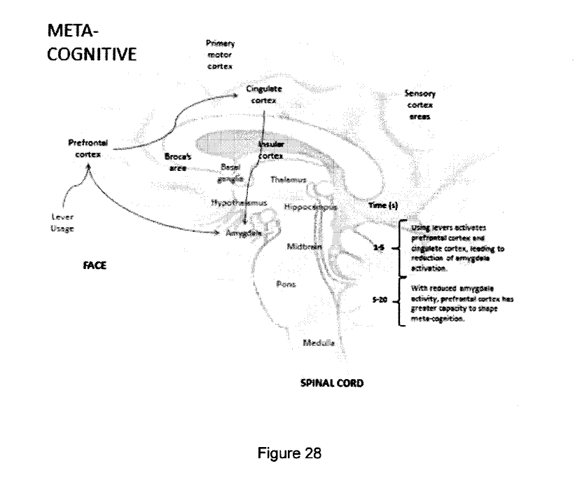

FIGS. 25-28 shown brain maps showing causal effects of levers meant to change the emotional state fear by changing the neuro-physiological patterns that correspond to the phenomenological components of that state.

An embodiment may then calculate by associating to the brain and body maps of fear a set of executable actions (i.e. levers) that are most likely to change one or more of the phenomenological components of the emotional state by making changes to the brain-body mechanisms and patterns that the various components of the emotional states are likely to supervene upon. As noted earlier, in the database, records of levers are provided. Ranking scores of a set of levers, when executed for a specific emotional state may be provided, which may be based on statistical information provided on the effectiveness of each lever in effecting (a change from) the emotional state. FIG. 16 shows a set of levers determined by the system on the basis of inputs from the subject regarding the various components of the emotional state fear, and of the associated brain maps and body maps of the neuro-physiological mechanisms associated with the phenomenological components of fear. These levers are presented to the subject along with displays of the causal effects of using the levers on the functional brain map and body map associated with the fear state (see FIGS. 25-28).

Levers are presented to the subject in combinations of up to N, where, according to one embodiment of the disclosure, N=3, but may range in values from 1 to 30 or more. The subject chooses a combination of levers, records them into the system, and attempts to deploy them in a next instantiation of an emotional episode in which the emotional state fear is instantiated. In one embodiment, the system also computes the set of permutations of the combination of levers selected by the subject that is most likely to produce a change in the emotional state of the subject, and prompts the user to choose one of the permutations. The system then provides GUIs for the subject to input the results of his use of the chosen combination and permutation of levers in the form of the subjects responses to a set of questions regarding the effectiveness of the levers in having produced the desired emotional state change (on a scale of 1 to M, with M=7 according to one embodiment) and stores these results.

According to another embodiment, the system computes prior probabilities for the causal efficacy of the subject's use of the various combinations and permutations of the levers, and then computes posterior probabilities for the causal efficacy of each of the permutations and combinations of levers that the subject used, based on input from the subject given in response to a set of questions about the causal efficacy of the levers, which, according to one embodiment, the subject supplies with a binary answer (yes/no; 1/0). The system tracks the (weighted) efficacy score (or posterior probability of causal efficacy) of the levers and ranks the combinations and permutations of levers as a function of their most recently computed causal efficacy. It supplies the subject with an ongoing set of suggestions that may be chose by the subject to be either biased towards EXPLOITATION (choose the levers most likely to work in the future because they have the highest efficacy or expected efficacy score for the subject, or the highest posterior probability of efficacy for the subject in a given state) or towards EXPLORATION (choose new levers and new permutations and combinations of levers). The EXPLOITATION-EXPLORATION biasing is performed according to one embodiment by choosing suitable constants A and B (ranging from 0 to 1, and such that A+B=1) and choosing the combination-permutation (Sⱼ) of levers (lᵢ) that maximizes

$$V = A {\sum }_{j = 0}^{M} {p}_{j} v ( {S}_{j} ) + B {\sum }_{j = 1}^{L} {p}_{j} {log}_{2} \frac{1}{{p}_{j}} . \qquad Equation 1$$

This equation may be used in part to calculate ranking scores and/or select levers for various levers against a specific emotional state.

Now details on processing a disgust state are described for an embodiment. One embodiment provides facilities to receive input data, process the data and produces outputs to assist a subject to change from or out of the emotional state disgust by changing the specific cortical and physiological responses associated with it, on the basis of an underlying brain map and body map of the emotional state.

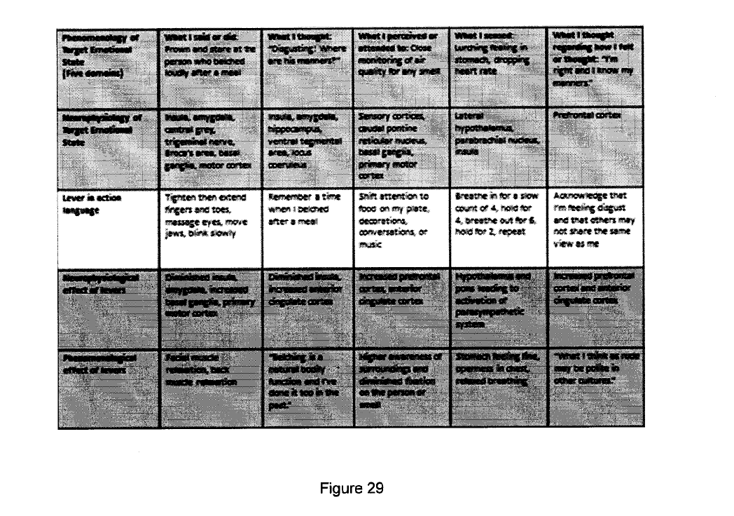

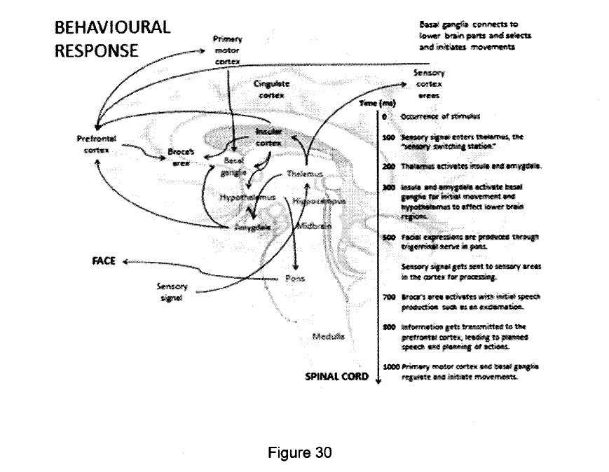

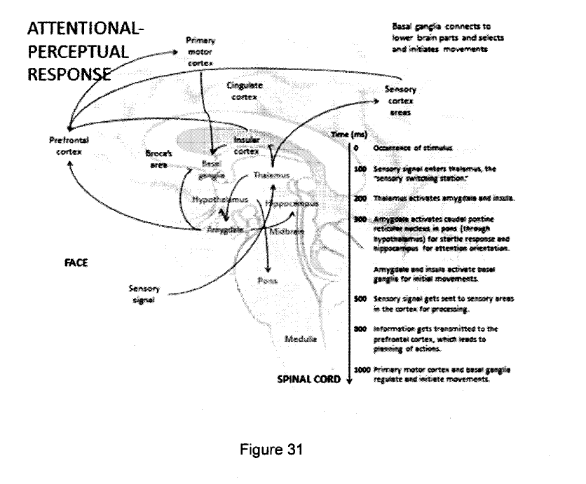

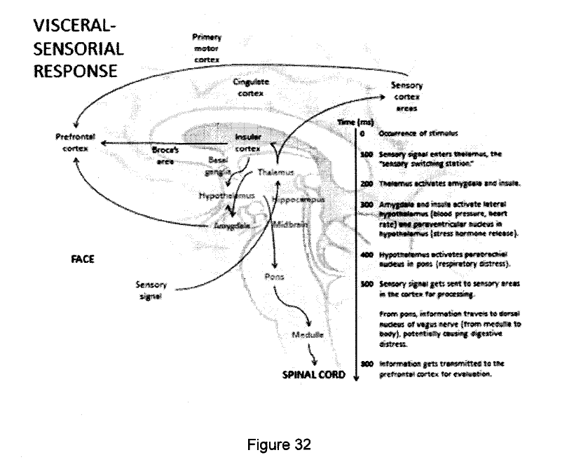

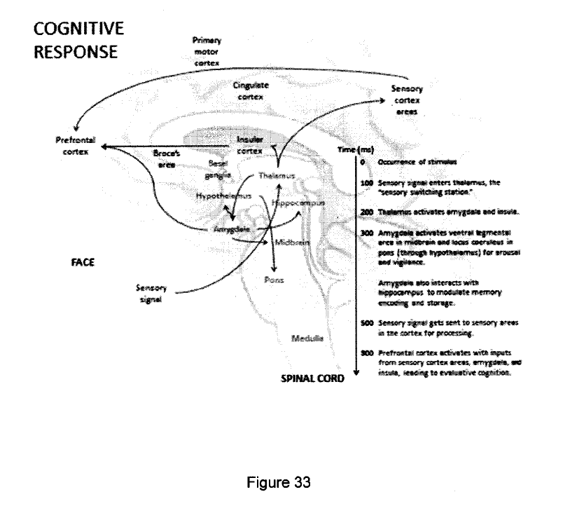

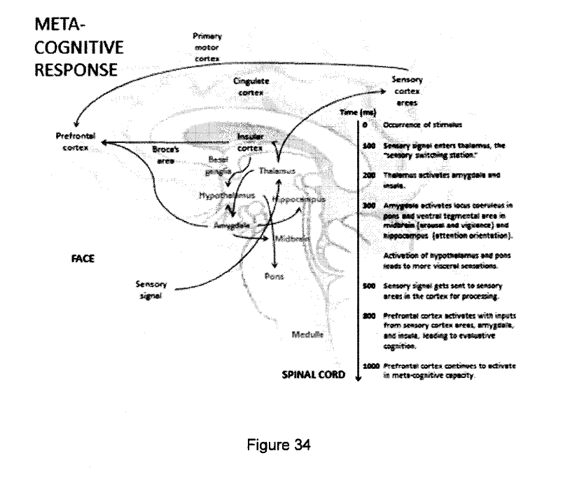

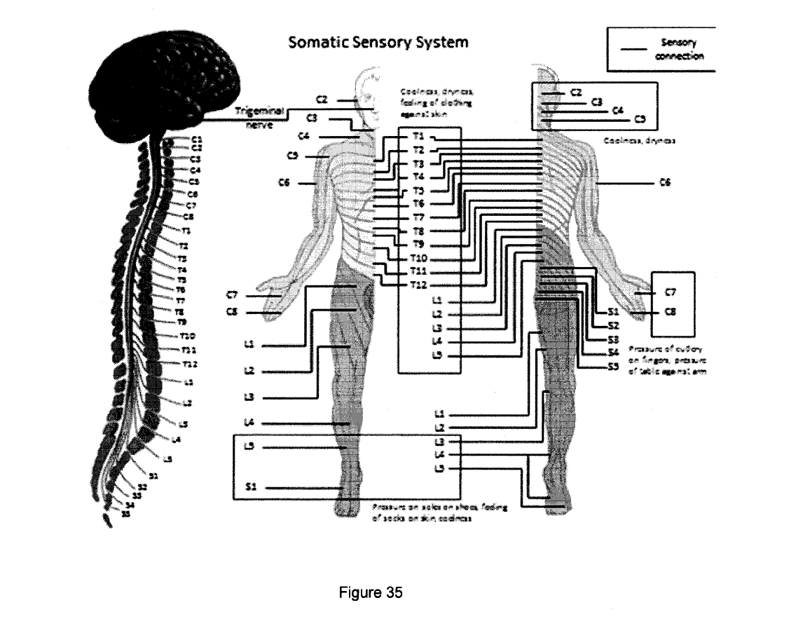

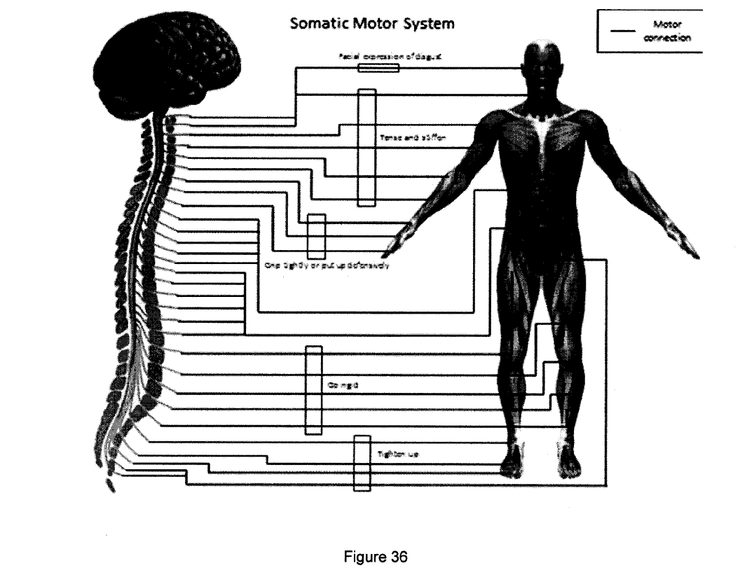

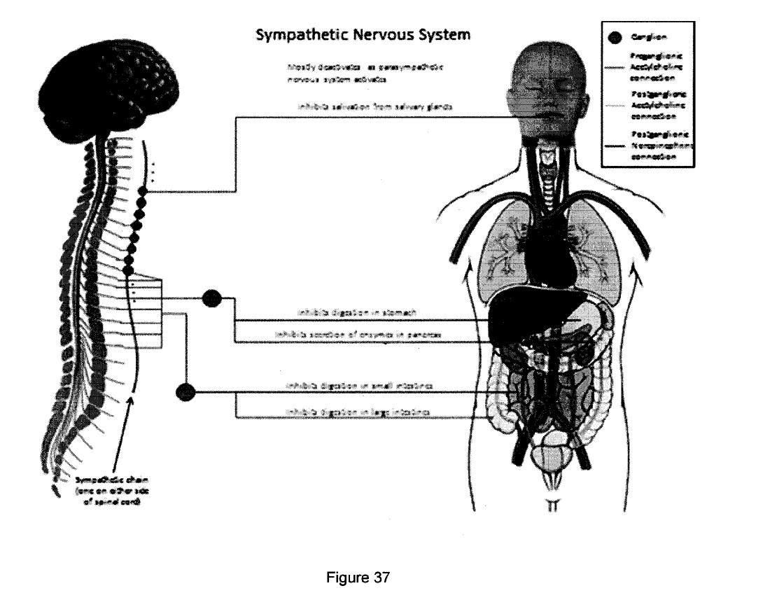

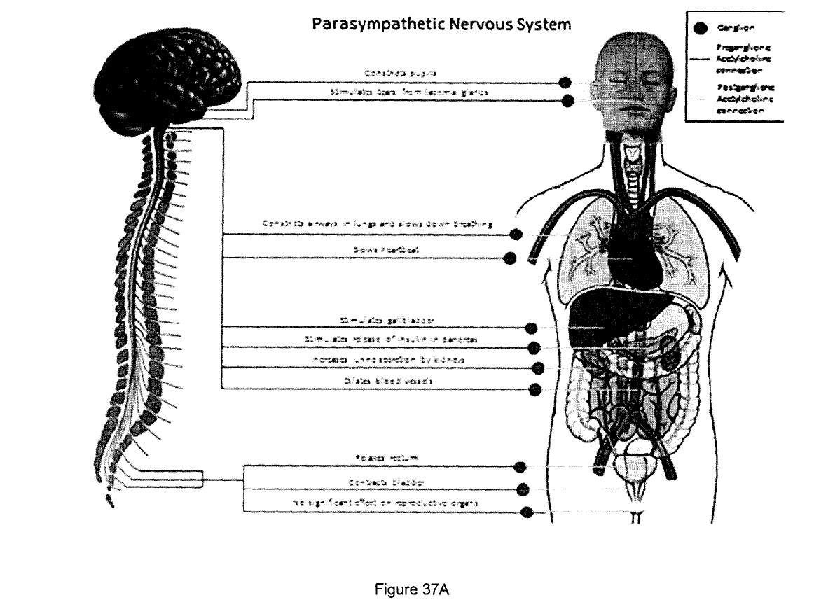

FIG. 29 shows a summary of outputs of each stage of the features for producing a change of the emotional state disgust as it arises in a specific emotional episode. FIGS. 30-34 show brain maps for neurophysiological correlates of the disgust state. In each of FIGS. 30-34 a series of responses are shown (as arrows) as they pass through various parts of the brain. A timeline shows the progression of each response for the disgust state. As noted above, an embodiment may have discrete data on a subject's responses that may be used to detect when disgust is being felt by the user. FIGS. 35-38 show body maps for neurophysiological correlates of the disgust state. The text of the responses and the timelines of FIGS. 29-34 are incorporated into this specification.

The subject first maps the attentional-perceptual, sensory-visceral, cognitive and meta-cognitive states associated with his disgust response (see FIG. 29). A computer system, using an associated database, then computes and displays to the subject a set of brain maps and body maps associated with the disgust emotional state (see FIGS. 30-34 and FIGS. 35-37).

The subject learns, via a Brain Map, that there is a brain pattern that involves the processing of a disgusting stimulus (an image, perceived or remembered, or some other sensory signal such as a foul smell) in the thalamus which feeds into the insula and the amygdala information which de-activates (Body Map) the sympathetic nervous system (causing constricted inspiration) and differentially activates the parasympathetic nervous system (causing secretion of pancreatic juice, relaxation of rectum), de-activates the parabrachial nucleus (causing decreased respiration-slower breathing).

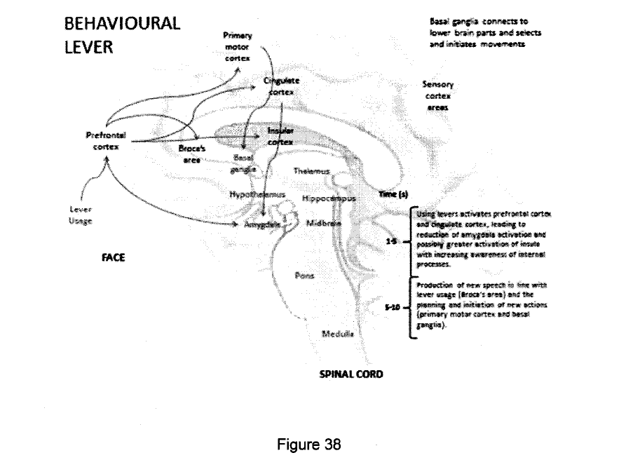

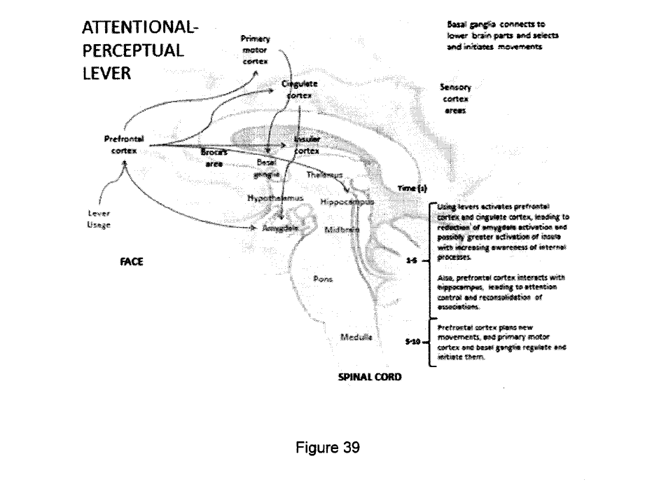

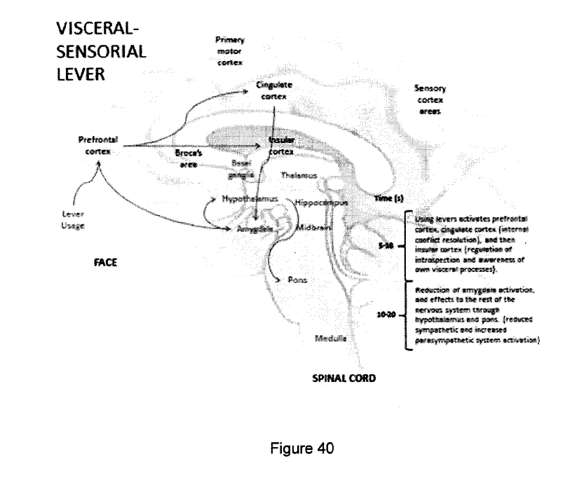

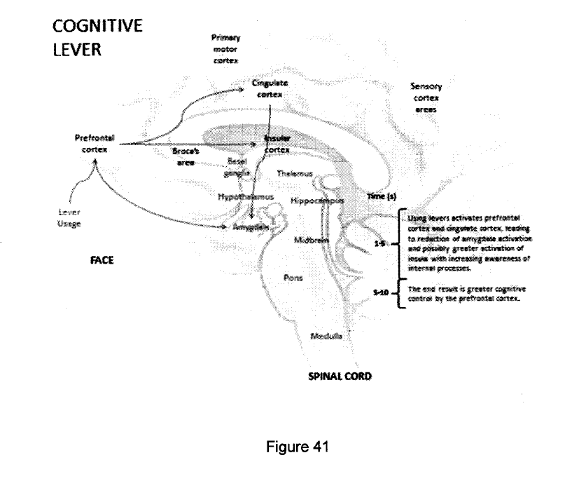

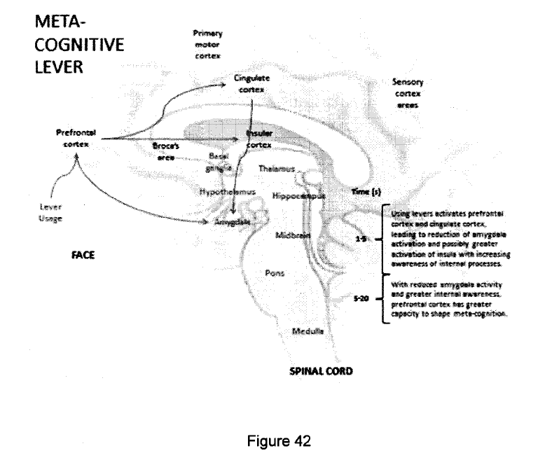

FIG. 29 shows a set of levers that are computed by the system on the basis of inputs from the subject regarding the various components of the emotional state disgust, and of the associated brain maps and body maps of the neuro-physiological mechanisms associated with the phenomenological components of disgust. These levers are presented to the subject along with displays of the causal effects of using the levers on the functional brain map and body map associated with the disgust state (see FIGS. 38-42). FIGS. 38-42 show brain maps showing causal effects of levers meant to enable the user to modify or transform the emotional state disgust by changing the neuro-physiological patterns that correspond to the phenomenological components of that state.

As noted above, levers are presented to the subject in combinations of up to N. The subject chooses a combination of levers, records them into the system, and attempts to deploy them in the next instantiation of an emotional episode in which the emotional state disgust is instantiated. According to one embodiment, the system also computes the set of permutations of the combination of levers selected by the subject that is most likely to produce a change in the emotional state of the subject, and prompts the user to choose one of the permutations. The system then provides outputs, screens and GUIs for the subject to input the results of his use of the chosen combination and permutation of levers in the form of the subjects responses to a set of questions regarding the effectiveness of the levers in having produced the desired emotional state change (on a scale of 1 to M, with M=7 according to one embodiment) and stores these results. According to another embodiment, the system computes prior probabilities for the causal efficacy of the subjects use of the various combinations and permutation of the levers, and then computes posterior probabilities for the causal efficacy of each of the permutation and combination of levers that the subject used, based on input from the subject given in response to a set of questions about the causal efficacy of the levers, which, according to one embodiment, the subject supplies with a binary answer. The system tracks the weighted efficacy score (or posterior probability of causal efficacy) of the levers and ranks the combinations and permutations of levers as a function of their most recently computed causal efficacy. It supplies the subject with an ongoing set of suggestions that may be chose by the subject to be either biased towards EXPLOITATION (choose the levers most likely to work in the future because they have the highest efficacy or expected efficacy score for the subject, or the highest posterior probability of efficacy for the subject in a given state) or towards EXPLORATION (choose new levers and new permutations and combinations of levers). The EXPLOITATION-EXPLORATION biasing is performed according to one embodiment by choosing suitable constants A and B (ranging from 0 to 1, and such that A+B=1) and choosing the combination-permutation (Sⱼ) of levers (lᵢ) that maximizes

$$V = A {\sum }_{j = 0}^{M} {p}_{j} v ( {S}_{j} ) + B {\sum }_{j = 1}^{L} {p}_{j} {log}_{2} \frac{1}{{p}_{j}} . \qquad Equation 2$$

This equation may be used in part to calculate ranking scores and/or select levers for various levers against a specific emotional state.

Now details on processing an anger state are described for an embodiment. One embodiment provides facilities to receive input data, process the data and produces outputs to assist a subject to transition out of the emotional state anger by changing the specific cortical and physiological responses associated with it, on the basis of an underlying brain map and body map of the emotional state.

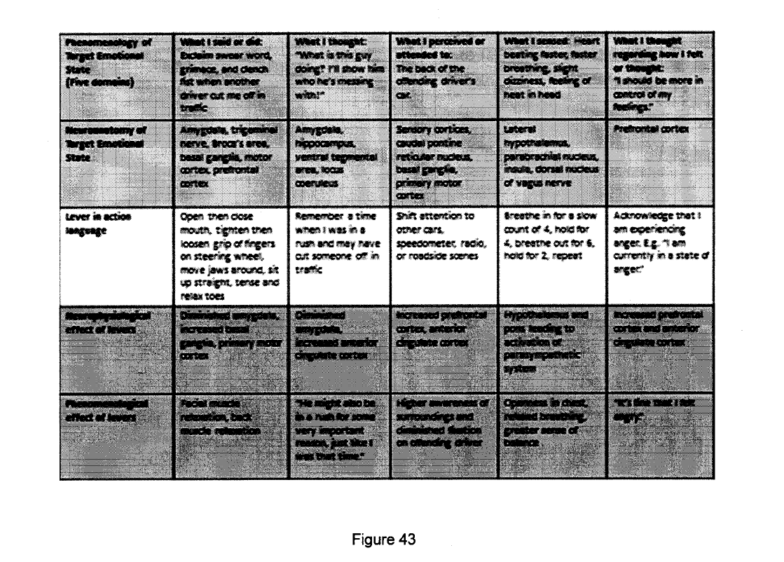

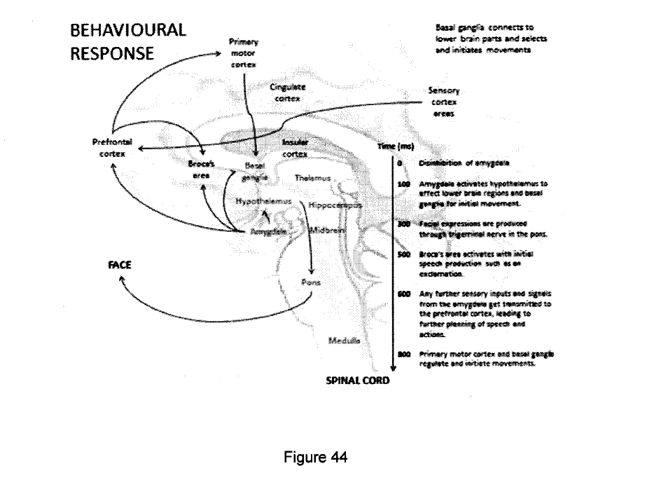

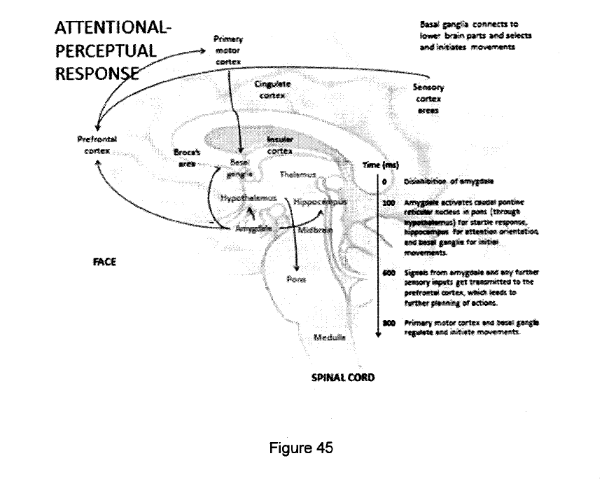

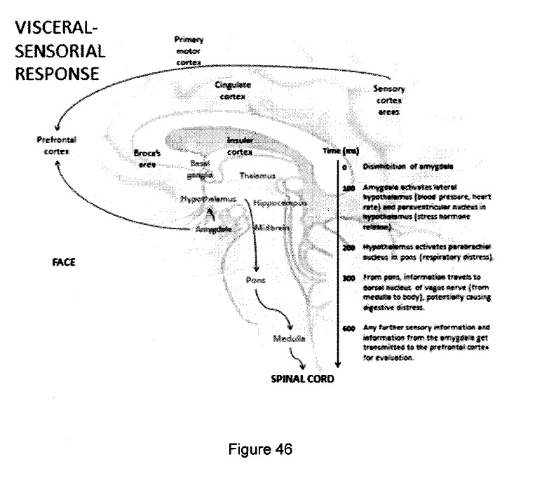

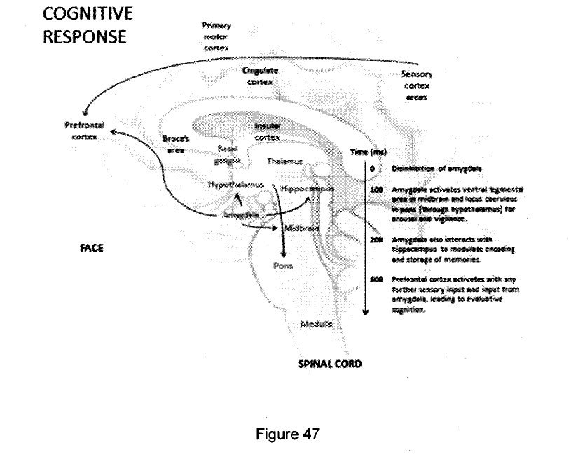

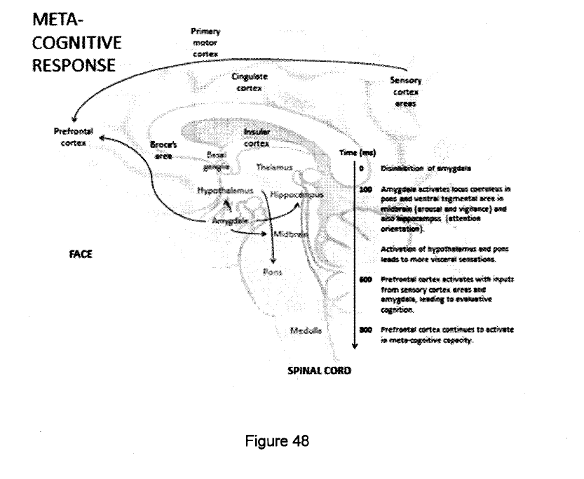

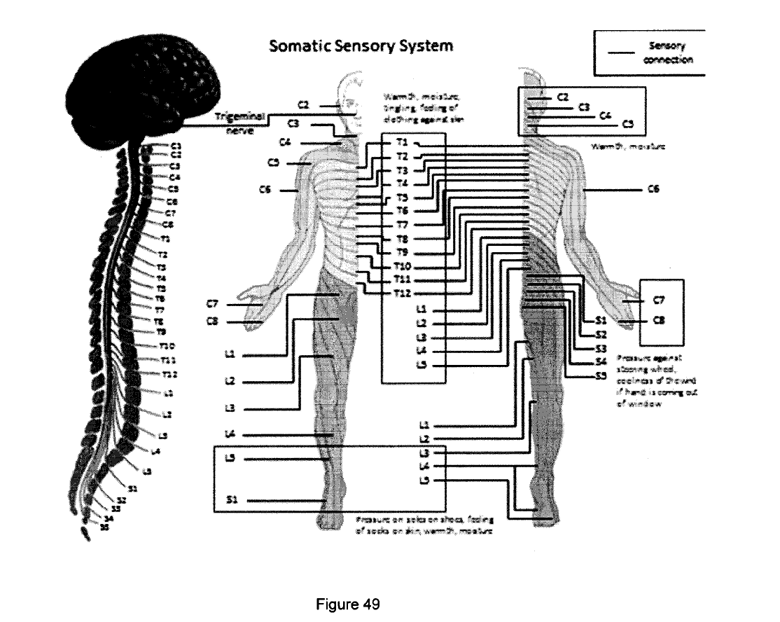

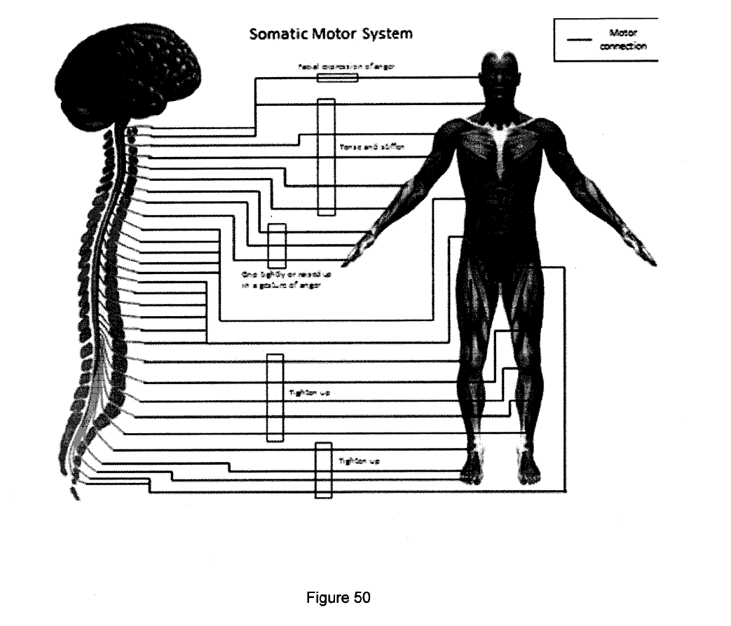

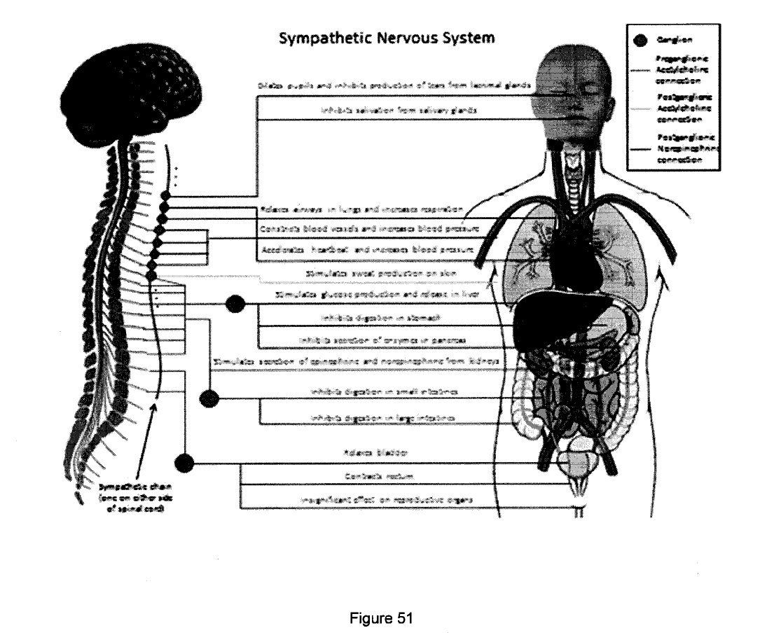

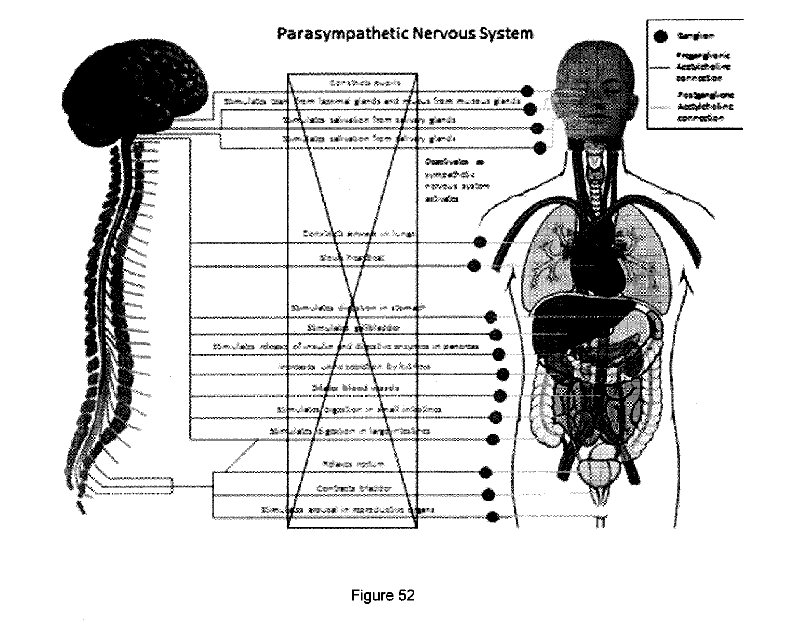

FIG. 43 shows a summary of outputs of each stage of outputs, screens and GUIs for producing a change of the emotional state anger as it arises in a specific emotional episode. FIGS. 44-48 show brain maps for neurophysiological correlates of the anger state. In each of FIGS. 44-48 a series of responses are shown (as arrows) as they pass through various parts of the brain. A timeline shows the progression of each response for the anger state. As noted above, an embodiment may have discrete data on a subject's responses that may be used to detect when anger is being felt by the user. FIGS. 49-52 show body maps for neurophysiological correlates of the anger state. The text of the responses and the timelines of FIGS. 43-52 are incorporated into this specification.

The subject first maps the attentional-perceptual, sensory-visceral, cognitive and meta-cognitive states associated with his anger response (see FIG. 43). A computer system, using an associated database, then computes and displays to the subject a set of brain maps and body maps associated with the anger emotional state (see FIGS. 44-48 and FIGS. 49-52).

The subject learns, via a Brain Map, that there is a brain pattern that involves processing of a stimulus (an image, perceived or remembered, or a propositional thought) that is representative of anger which begins via the disinhibition of the amygdala and the ensuing activation of the hypothalamus and, thereby, of brain regions associated with somatic-sensory and somatic motor function. Parabrachial nucleus activation, in the pons, through the hypothalamus is causally linked to faster and shallower breathing (respiratory distress) functions. Pre-frontal cortex activation corresponds to the experience of propositional thoughts or images related to the destruction of the source of the stimulus, and is maintained by the increased activity states of the amygdala, the hypothalamus and the regions of the brain coordinating lower (visceral-motor) functions. The subjects learns, via Body Map, that parasympathetic nervous system de-activation corresponds to lower level of gastric juice secretion while the concomitant activation of the sympathetic nervous system—with the attending secretion of epinephrine and nor-epinephrine—is causally linked to an increase in heart rate.

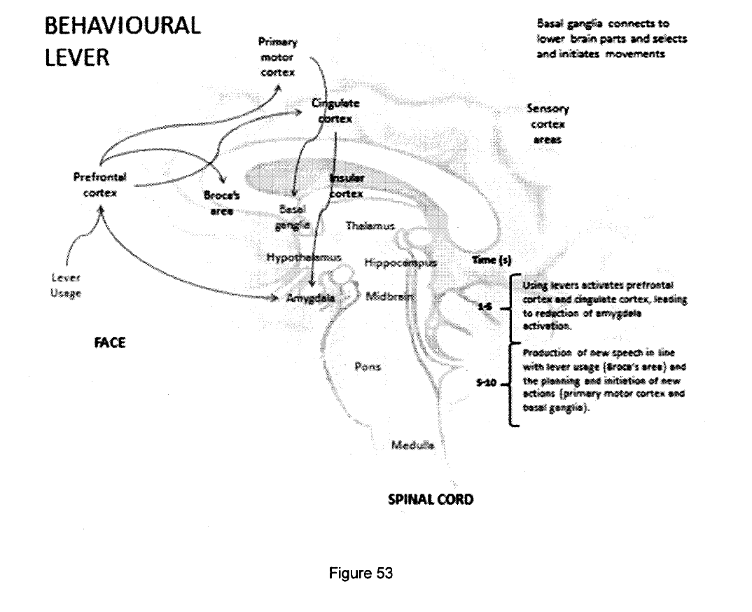

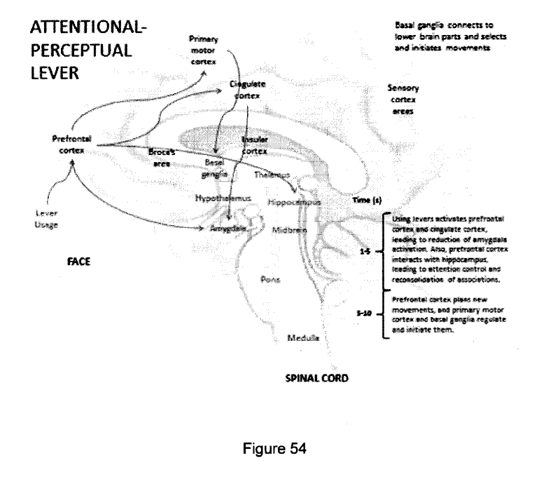

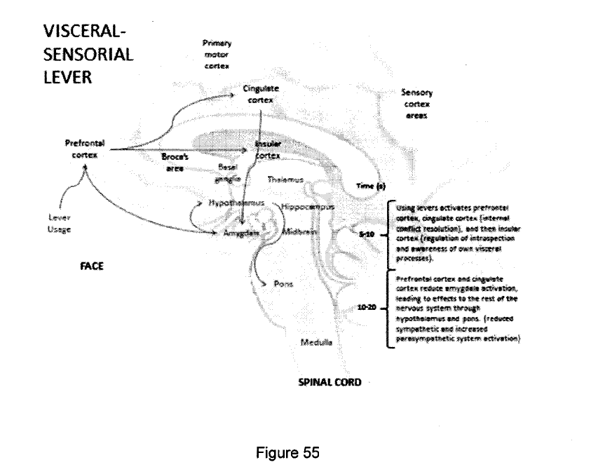

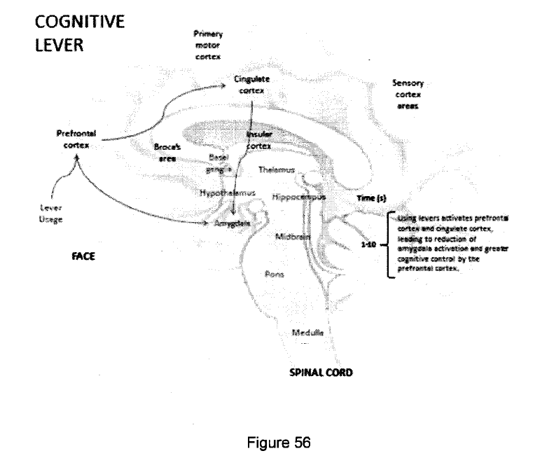

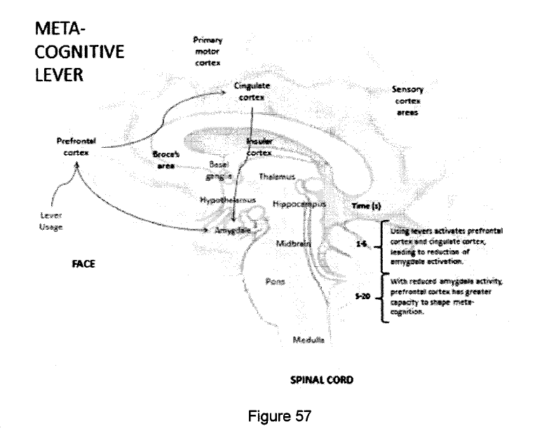

FIG. 43 shows a set of levers that are computed by the system on the basis of inputs from the subject regarding the various components of the emotional state anger, and of the associated brain maps and body maps of the neuro-physiological mechanisms associated with the phenomenological components of anger. These levers are presented to the subject along with displays of the causal effects of using the levers on the functional brain map and body map associated with the anger state (see FIGS. 53-57). FIGS. 53-57 show brain maps showing causal effects of levers meant to enable the user to modify or transform the emotional state anger by changing the neuro-physiological patterns that correspond to the phenomenological components of that state.

Levers are presented to the subject in combinations of up to N. The subject chooses a combination of levers, records them into the system, and attempts to deploy them in the next instantiation of an emotional episode in which the emotional state anger is instantiated. In one embodiment of the disclosure, the system also computes the set of permutations of the combination of levers selected by the subject that is most likely to produce a change in the emotional state of the subject, and prompts the user to choose one of the permutations. The system then provides outputs, screens and GUIs for the subject to input the results of his use of the chosen combination and permutation of levers in the form of the subjects responses to a set of questions regarding the effectiveness of the levers in having produced the desired emotional state change (on a scale of 1 to M, with M=7 according to one embodiment) and stores these results. Accordingly to another embodiment, the system computes prior probabilities for the causal efficacy of the subjects use of the various combinations and permutation of the levers, and then computes posterior probabilities for the causal efficacy of each of the permutation and combination of levers that the subject used, based on input from the subject given in response to a set of questions about the causal efficacy of the levers, which, according to one embodiment, the subject supplies with a binary answer (yes—1, no—0). The system tracks the weighted efficacy score (or posterior probability of causal efficacy) of the levers and ranks the combinations and permutations of levers as a function of their most recently computed causal efficacy. It supplies the subject with an ongoing set of suggestions that may be chose by the subject to be either biased towards EXPLOITATION (choose the levers most likely to work in the future because they have the highest efficacy or expected efficacy score for the subject, or the highest posterior probability of efficacy for the subject in a given state) or towards EXPLORATION (choose new levers and new permutations and combinations of levers). The EXPLOITATION-EXPLORATION biasing is performed according to one embodiment by choosing suitable constants A and B (ranging from 0 to 1, and such that A+B=1) and choosing the combination-permutation (Sⱼ) of levers (lᵢ) that maximizes

$$V = A {\sum }_{j = 0}^{M} {p}_{j} v ( {S}_{j} ) + B {\sum }_{j = 1}^{L} {p}_{j} {log}_{2} \frac{1}{{p}_{j}} . \qquad Equation 3$$

This equation may be used in part to calculate ranking scores and/or select levers for various levers against a specific emotional state.

Thus, according to one embodiment of the disclosure, there is provided a computer system (or data processing system 300) for providing a human subject with a set of one or more actions intended to modify or transform an emotional state of the human subject, including: at least one processor; and, one or more storage media containing software code and a database, which software, when executed by the processor, causes the computer system to: prompt the human subject for input regarding his current emotional state; receive input from the human subject representative of his emotional state; determine, based on the input and by accessing a database to which the input is compared, one or more actions intended to cause a modification or transformation in the emotional state of the human subject; provide a description of at least one action that is sufficiently detailed to allow the human subject to initiate and perform the action; prompt the human subject for feedback regarding the success of the action in changing said emotional state; and, update the database according to the input received from the human subject.

In the above computer system, the system may receive inputs directly from sensors attached to or otherwise situated to the human subject (i.e. fMRI). The feedback regarding the outcome of each action may be tracked directly by the sensors. The input may be representative of an undesirable emotional state. The input from the human subject may also contain information regarding a desired emotional state that the human subject would like to reach by performing a suggested action or action sequence. The undesirable emotional state may be represented by a plurality of phenomenological states. The plurality of phenomenological states may include behavioral, attentional-perceptual, sensory-visceral, cognitive, and meta-cognitive states. The database may be updated according to input of the human subject regarding the success of the action or actions. The database may be updated according to the feedback of the sensors. Suggested actions may be themselves updated according to the updated database. Also, the suggested actions may be themselves updated according to the feedback of the sensors.

According to another embodiment of the disclosure, there is provided a method for providing a human subject with one or more actions intended to change the human subject's brain activation state, including: receiving, as input into a computing device, information that identifies a first emotional state of the human subject and also information that identifies a second emotional state; determining, by the computing device accessing a database and based on the first and second emotional states, a first brain activation pattern associated with the first emotional state of the human subject and also a second brain activation pattern associated with the second emotional state; determining, by the computing device accessing the database and based on the first and second brain activation states, at least one action to be performed by the human subject with the goal of changing the first brain activation pattern to the second brain activation state; and, outputting from the computing device information that allows the human subject to understand and perform the at least one action with the goal of producing a change in the human subject's brain from the first brain activation pattern to the second brain activation pattern and thus also changing the human subject's emotional state from the first emotional state to the second emotional state.

In the above method, the first emotional state of the human subject may be an undesirable emotional state. The second emotional state may be an emotional state different than the undesirable emotional state of the human subject. The second emotional state may be a desirable emotional state. Each of the first and second emotional states may be represented by a plurality of phenomenological states. The plurality of phenomenological states may include behavioural, attentional-perceptual, visceral-sensorial, cognitive, and meta-cognitive. A brain activation pattern may be defined as one or more of: a set of neuroanatomical structures in the brain that may be implicated in the instantiation of the emotional state and the additional emotional state of the human subject; and, a set of excitation patterns of the neuroanatomical structures corresponding to the activation of the structures via chemical and electrical signals traveling between them. A brain activation pattern may be defined as one or more of: a set of neuroanatomical structures in the brain that may be implicated in the instantiation of the emotional state and the additional emotional state of the human subject; a set of excitation patterns of the neuroanatomical structures corresponding to the activation of the structures via chemical and electrical signals traveling between them; and, a set of time constants characterizing the differential delays in excitation patterns of the neuroanatomical structures. A brain activation pattern may be defined as one or more of: a set of neuroanatomical structures in the brain that may be implicated in the instantiation of the emotional state and the additional emotional state of the human subject; a set of excitation patterns of the neuroanatomical structures corresponding to the activation of the structures via chemical and electrical signals traveling between them; and, a set of anatomical structures in the body that are implicated in the instantiation of the emotional state and the additional emotional state. A brain activation pattern may be defined as one or more of: a set of neuroanatomical structures in the brain that are implicated in the instantiation of the emotional state and the additional emotional state of the human subject; a set of excitation patterns of the neuroanatomical structures corresponding to the activation of the structures via chemical and electrical signals traveling between them; a set of anatomical structures in the body that are implicated in the instantiation of the emotional state and the additional emotional state; and, a set of time constants characterizing the differential delays in excitation patterns of the neuroanatomical structures and the anatomical structures. The brain pattern may be determined by direct imaging of the subject's brain. The brain pattern may be determined by functional magnetic resonance imaging of the brain of the subject. The brain pattern may be determined by electroencephalographic imaging of the human subject's brain. And, the brain pattern may be determined by positron emission tomography of the brain of the human subject. The patterns may be output to the user along with the one or more actions.

According to one embodiment, each of the above method steps may be implemented by a respective software module 331. According to another embodiment, each of the above method steps may be implemented by a respective hardware module 321. According to another embodiment, each of the above method steps may be implemented by a combination of software 331 and hardware modules 321. According to another embodiment, each of the inputs to the system 300 from or about a user and/or a user's experience(s) may be stored in textual, audio and/or video records; each of the outputs from the system 300 to or about a user and/or a user's experience(s) may be stored in textual, audio and/or video records; these records may be accessed by the system to enable the system to provide outputs to the user which are increasingly (statistically) relevant to the user based on the user's recorded experiences employing the methods) and based on the user's success/failure employing the method(s); these records may be accessed by the user to enable the user to provide inputs to the system in the future which are increasingly contextually precise and relevant as would be the case with anyone of average ability learning a new skill and/or learning to use a new application/appliance/tool/technique; these records may also be accessed by a user's designate (i.e. coach, teacher, trainer, colleague, family member, friend etc.) to provide outputs to aid the designate in assisting/supporting/enabling the user to employ the method(s) and/or to provide outputs to aid the user in understanding and implementing guidance from the designate when they are assisting/supporting/enabling the user to employ the methods. According to another embodiment the user and/or the user's designates may be provided a series of GUIs and a system for organizing and navigating the GUIs (a “user operating system” for the system 300) that present to the user textual, audio and/or video information such as representations of the user's inputs and outputs, representations of other users' inputs and outputs, general educational information and information which the system calculates to be demographically/psychographically/contextually/statistically relevant and/or statistically correlated, interfaces to better enable the user to employ the system and the method(s). According to another embodiment the user will be provided with interfaces to the operating and/or other systems of vendors of computer software and hardware such as Microsoft Windows, Apple 10S, Google Android and providers of web based services such as Facebook and LinkedIn which the user may employ to enable their use of the system according to their current or future use of such systems to automate and organize their actions on a daily basis (i.e. calendar entries in Outlook, reminders, textual messages, notes etc.).

Referring to FIG. 63, according to another embodiment data relating to states, levers and results can be distributed among users. For example an embodiment provides data sharing among two or more users that are separately accessing the system. An embodiment enables the users to share data on actions that they have individually undertaken using the system to address emotional episode(s) or undesirable situation(s) that they are individually experiencing. The feature takes the inputs of each user according to the method(s) described herein and provides a range of outputs in the form of actions/levers that one or both users may take/employ to modify or transform the emotional state(s) of one or more such users according to the method(s) where one or more users benefit(s) from understanding the other user(s)′ emotional state(s), the actions/levers they (choose to) take/employ and the outcomes that result from choosing and taking/employing and/or not taking/employing those actions/levers relative to the emotional episode or undesirable situation.

According to another embodiment data relating to states, levers and results can be distributed among users. For example an embodiment provides data sharing among two or more users that are separately accessing the system. An embodiment enables the users to share data on actions that they have individually undertaken using the system to address emotional episode(s) or undesirable situation(s) that they are individually experiencing. The feature takes the inputs of each user according to the method(s) described herein and provides a range of outputs in the form of actions/levers that one or both users may take/employ to modify or transform the emotional state(s) of one or more such users according to the method(s) where one or more users benefit(s) from understanding the other user(s)′ emotional state(s), the actions/levers they (choose to) take/employ and the outcomes that result from choosing and taking/employing and/or not taking/employing those actions/levers relative to the emotional episode or undesirable situation.

For an embodiment, a method of calculating relevancies and correlations may use existing statistical ranking and analysis techniques. This may permit an embodiment to derive correlations across increasingly large numbers of users about new unique data from a user's experiences based on his inputs according to the emotional states he chooses to target, the objectives he has according to a goal states and other objectives he may record in the system, the actions/levers he takes/employs and outcomes that result from choosing and taking/employing and/or not taking/employing those actions/levers relative to the emotional episode or undesirable situation, the frequency/sequence/time/date he chooses to or chooses not to take/employ the actions/levers and the corresponding emotional states he experiences as recorded by him into the system and/or by (biometric) devices attached to him or otherwise situated to him. According to another embodiment the system database is augmentable with data of research and information from third party sources on emotional states (e.g. identification of additional states) and triggers (e.g. identification of additional triggers and the states that they affect) that complement the data from the users and is used to augment the outputs to the users. While this disclosure is primarily discussed as a method, a person of ordinary skill in the art will understand that the apparatus discussed above with reference to a data processing system 300 may be programmed to enable the practice of the method of the disclosure. Moreover, an article of manufacture for use with a data processing system 300, such as a pre-recorded storage device or other similar computer readable medium or product including program instructions recorded thereon, may direct the data processing system 300 to facilitate the practice of the method of the disclosure. It is understood that such apparatus and articles of manufacture also come within the scope of the disclosure.

In particular, the sequences of instructions which when executed cause the method described herein to be performed by the data processing system 300 may be contained in a data carrier product according to one embodiment of the disclosure. This data carrier product may be loaded into and run by the data processing system 300. In addition, the sequences of instructions which when executed cause the method described herein to be performed by the data processing system 300 may be contained in a computer program or software product according to one embodiment of the disclosure. This computer program or software product may be loaded into and run by the data processing system 300. Moreover, the sequences of instructions which when executed cause the method described herein to be performed by the data processing system 300 may be contained in an integrated circuit product (e.g., a hardware module or modules 321) which may include a coprocessor or memory according to one embodiment of the disclosure. This integrated circuit product may be installed in the data processing system 300.

It will be appreciated that the embodiments relating to client devices, server devices and systems may be implemented in a combination of electronic modules, hardware, firmware and software. The firmware and software may be implemented as a series of processes, applications and/or modules that provide the functionalities described herein. The modules, applications, algorithms and processes described herein may be executed in different order(s). Interrupt routines may be used. Data, applications, processes, programs, software and instructions may be stored in volatile and non-volatile devices described and may be provided on other tangible medium, like USB drives, computer discs, CDs, DVDs or other substrates herein and may be updated by the modules, applications, hardware, firmware and/or software. The data, applications, processes, programs, software and instructions may be sent from one device to another via a data transmission.

As used herein, the wording “and/or” is intended to represent an inclusive-or. That is, “X and/or Y” is intended to mean X or Y or both.

In this disclosure, where a threshold or measured value is provided as an approximate value (for example, when the threshold is qualified with the word “about”), a range of values will be understood to be valid for that value. For example, for a threshold stated as an approximate value, a range of about 25% larger and 25% smaller than the stated value may be used. Thresholds, values, measurements and dimensions of features are illustrative of embodiments and are not limiting unless noted. Further, as an example, a “sufficient” match with a given threshold may be a value that is within the provided threshold, having regard to the approximate value applicable to the threshold and the understood range of values (over and under) that may be applied for that threshold.

The disclosure is defined by the claims appended hereto, with the foregoing description being merely illustrative of embodiments of the disclosure. Those of ordinary skill may envisage certain modifications to the foregoing embodiments which, although not explicitly discussed herein, do not depart from the scope of the disclosure, as defined by the appended claims.

1-32. (canceled)

33. A computer system for identifying a set of actions to transition an emotional state of a user from a first emotional state to a goal emotional state, comprising:
a display;
a processor;
a database of emotional states accessible by the processor; and
a memory device that has instructions for execution on the processor to cause the processor to:
obtain data relating to the first emotional state and the goal emotional state of a user;
analyze the data relating to the first emotional state and the goal emotional state against the database to identify a set of levers to transition the emotional state of a user from the first emotional state to the goal emotional state; and
display at least one action associated with at least one lever of the set of levers in a graphical user interface (GUI) on the display.

34. The computer system for identifying a set of actions to transition an emotional state of a user as claimed in claim 33, wherein the memory device has further instructions for execution on the processor to cause the processor to:
generate an input GUI on the display to show prompts for the data relating to the first emotional state and the goal emotional state.

35. The computer system for identifying a set of actions to transition an emotional state of a user as claimed in claim 33, wherein the memory device has further instructions for execution on the processor to cause the processor to:
evaluate the set of levers using user-specific data and the database to rank entries in the set of levers based on a prediction of success; and
display an ordered list of the set of levers in the GUI.

36. The computer system for identifying a set of actions to transition an emotional state of a user as claimed in claim 33, wherein the memory device has further instructions for execution on the processor to cause the processor to:
further evaluate the set of levers using phenomenological components of the emotional states.

37. The computer system for identifying a set of actions to transition an emotional state of a user as claimed in claim 33, wherein in the database the emotional state has a set of components including at least one of:
a behavioural (B) component reflecting a behaviour of the user;
an attentional-perceptual (AP) component reflecting what the user perceived or perceives;
a visceral-sensorial (VS) component reflecting what the user sensed or senses;
a cognitive (C) component reflecting what the user thought or thinks; and
a meta-cognitive (MC) component reflecting what the user thought or thinks about what the user thought or thinks.

38. The computer system for identifying a set of actions to transition an emotional state of a user as claimed in claim 33, wherein:
the goal emotional state is any emotional state other than the first emotional state.

39. The computer system for identifying a set of actions to transition an emotional state of a user as claimed in claim 33, wherein the database further comprises:
data relating to a series of epochs of other emotional states providing a phenomenological portrait for the emotional state.

40. The computer system for identifying a set of actions to transition an emotional state of a user as claimed in claim 39, wherein the memory device has further instructions for execution on the processor to cause the processor to:
generate a series of GUIs on the display for a training sequence to prompt for data to refine a boundary of an epoch in the series of epochs; and
identify components of the set of components that occur in the epoch.

41. The computer system for identifying a set of actions to transition an emotional state of a user as claimed in claim 37, wherein the memory device has further instructions for execution on the processor to cause the processor to:
generate a series of GUIs on the display to show at least one brain function involved in transitioning from the first emotional state in a neurophysiological map.

42. The computer system for identifying a set of actions to transition an emotional state of a user as claimed in claim 41, wherein the series of GUIs also:
show at least one body system structure involved in transitioning from the first emotional state in the neurophysiological map.

43. The computer system for identifying a set of actions to transition an emotional state of a user as claimed in claim 36, wherein the memory device has further instructions for execution on the processor to cause the processor to:
obtain feedback data on effectiveness of the at least one action in transitioning from the first emotional state of the user; and
store the feedback data in the database in a record associated with the user.

44. The computer system for identifying a set of actions to transition an emotional state of a user as claimed in claim 43, wherein the memory device has further instructions for execution on the processor to cause the processor to:
analyze the feedback data to identify a common criteria to refine a predictive model for the at least one lever.

45. The computer system for identifying a set of actions to transition an emotional state of a user as claimed in claim 43, wherein the memory device has further instructions for execution on the processor to cause the processor to:
evaluate the feedback data to determine whether success has been achieved in transitioning to the goal emotional state of the user; and
when success has not been achieved, display in the GUI at least one action associated with a second lever of the set of levers.

46. The computer system for identifying a set of actions to transition an emotional state of a user as claimed in claim 44, wherein:
the database further comprises data relating an emotional state of a second user; and
the memory device has further instructions for execution on the processor to cause the processor to
share data regarding the emotional state of the user and the emotional state of the second user.

47. The computer system for identifying a set of actions to transition an emotional state of a user as claimed in claim 46, wherein the memory device has further instructions for execution on the processor to cause the processor to
display on the GUI a lever associated with the emotional state of the second user.

48. A computer-based method for identifying a set of actions to transition an emotional state of a user from a first emotional state to a goal emotional state, comprising:
obtaining data relating to the first emotional state and the goal emotional state of a user;
analyzing the data relating to the first emotional state and the goal emotional state against a database of emotional states accessible by the processor to identify a set of levers to transition the emotional state of the user from the first emotional state to the goal emotional state; and
displaying at least one action associated with at least one lever of the set of levers in a graphical user interface (GUI) on the display.

49. The computer-based method as claimed in claim 48, wherein the database comprises further data for a set of components associated with the emotional state including at least one of:
a behavioural (B) component reflecting a behaviour of the user;
an attentional-perceptual (AP) component reflecting what the user perceived or perceives;
a visceral-sensorial (VS) component reflecting what the user sensed or senses;
a cognitive (C) component reflecting what the user thought or thinks; and
a meta-cognitive (MC) component reflecting what the user thought or thinks about what the user thought or thinks.

50. The computer-based method as claimed in claim 48, wherein the database further comprises:
data relating to a series of epochs of other emotional states providing a phenomenological portrait for the emotional state.

51. The computer-based method as claimed in claim 48, further comprising:
obtaining feedback data on effectiveness of the at least one action to change the emotional state of the user;
storing the feedback data in the database in a record associated with the user;
evaluating the feedback data to determine whether success has been achieved in transitioning to the goal emotional state of the user; and
when success has not been achieved, displaying at least one action associated with a second lever of the set of levers in the GUI.

52. The computer-based method as claimed in claim 48, further comprising:
accessing data in the database regarding the emotional state of the user and an emotional state of a second user; and
displaying in the GUI a lever associated with the emotional state of the second user.
